(19) United States
(12) Patent Application Publication
(10) Pub. No.: US 2023/0221530 A1
(43) Pub. Date: Jul. 13, 2023

(54) OPTICAL IMAGING LENS

(71) Applicant: GENIUS ELECTRONIC OPTICAL (XIAMEN) CO., LTD., Xiamen (CN)

(72) Inventors: Qingzhi Zhu, Xiamen (CN); Jiayuan Zhang, Xiamen (CN); Huabin Liao, Xiamen (CN)

(73) Assignee: GENIUS ELECTRONIC OPTICAL (XIAMEN) CO., LTD., Xiamen (CN)

(21) Appl. No.: 17/861,272

(22) Filed: Jul. 11, 2022

(30) Foreign Application Priority Data
Jan. 12, 2022 (CN) 202210032811.4

(51) Int. Cl. G02B 9/64; G02B 13/18

(52) U.S. Cl. CPC G02B 9/64; G02B 13/18

(57) ABSTRACT

An optical imaging lens, including a first lens element, a second lens element, a third lens element, a fourth lens element, a fifth lens element, a sixth lens element, a seventh lens element, an eighth lens element, and a ninth lens element disposed in sequence from an object side to an image side along an optical axis. An optical axis region of the object-side surface of the second lens element is convex. The fourth lens element has positive refracting power, and a periphery region of the image-side surface of the fourth lens element is concave. A periphery region of the object-side surface of the fifth lens element is concave. The seventh lens element has positive refracting power.

### CROSS-REFERENCE TO RELATED APPLICATION

This application claims the priority benefit of China application serial no. 202210032811.4, filed on Jan. 12, 2022. The entirety of the above-mentioned patent application is hereby incorporated by reference herein and made a part of this specification.

### BACKGROUND

### Technology Field

The invention relates to an optical element, and particularly to an optical imaging lens.

### Description of Related Art

The specifications of portable electronic devices innovate over time, and optical imaging lenses, the key elements, have diverse developments as well. The main lens of a portable electronic device not only requires a larger aperture but also maintains a short system length as well as pursuing higher pixel counts and higher resolution. The high pixel counts imply that an increase of the image height is required, and the pixel requirement is increased by using a larger image sensor to receive imaging rays. However, although the design of the large aperture allows the lens to receive more imaging rays, the design difficulty arises, and the high pixel resolution leads to a required improvement of the lens resolution. If the design requirements of the large aperture are to meet, the design difficulty may be doubled. Therefore, how to add multiple lenses to the limited system length of an optical imaging lens, meanwhile improve the resolution, and increase the aperture and image height altogether, is a problem that needs to be challenged and solved.

### SUMMARY

The invention provides an optical imaging lens capable of providing a lens with a larger aperture, a larger image height, and higher resolution. The optical imaging lens can be used for recording and shooting videos and applied to portable electronic products, such as mobile phones, cameras, tablet computers, personal digital assistants (PDA) or head-mounted displays (e.g., augmented Reality (AR) displays, virtual reality (VR) displays, or mixed reality (MR) displays), and the like.

An optical imaging lens according to an embodiment of the invention includes a first lens element, a second lens element, a third lens element, a fourth lens element, a fifth lens element, a sixth lens element, a seventh lens element, an eighth lens element, and a ninth lens element disposed in sequence from an object side to an image side along an optical axis, and each of the first lens element to the ninth lens element includes an object-side surface facing the object side and allowing imaging rays to pass through and an image-side surface facing the image side and allowing the imaging rays to pass through. An optical axis region of the object-side surface of the second lens element is convex. The fourth lens element has positive refracting power and a periphery region of the image-side surface of the fourth lens element is concave. A periphery region of the object-side surface of the fifth lens element is concave. The seventh lens element has positive refracting power. Lens elements of the optical imaging lens are only the nine lens elements described above.

An optical imaging lens according to an embodiment of the invention includes a first lens element, a second lens element, a third lens element, a fourth lens element, a fifth lens element, a sixth lens element, a seventh lens element, an eighth lens element, and a ninth lens element disposed in sequence from an object side to an image side along an optical axis, and each of the first lens element to the ninth lens element includes an object-side surface facing the object side and allowing imaging rays to pass through and an image-side surface facing the image side and allowing the imaging rays to pass through. A periphery region of the image-side surface of the fourth lens element is concave. A periphery region of the object-side surface of the fifth lens element is concave. An optical axis region of the image-side surface of the sixth lens element is concave. An optical axis region of the image-side surface of the seventh lens element is convex. Lens elements of the optical imaging lens are only the nine lens elements described above.

An optical imaging lens according to an embodiment of the invention includes a first lens element, a second lens element, a third lens element, a fourth lens element, a fifth lens element, a sixth lens element, a seventh lens element, an eighth lens element, and a ninth lens element disposed in sequence from an object side to an image side along an optical axis, and each of the first lens element to the ninth lens element includes an object-side surface facing the object side and allowing imaging rays to pass through and an image-side surface facing the image side and allowing the imaging rays to pass through. A periphery region of the image-side surface of the third lens element is concave. A periphery region of the object-side surface of the fourth lens element is convex, and a periphery region of the image-side surface of the fourth lens element is concave. A periphery region of the object-side surface of the fifth lens element is concave, and a periphery region of the image-side surface of the fifth lens element is convex. An optical axis region of the object-side surface of the sixth lens element is convex. Lens elements of the optical imaging lens are only the nine lens elements described above.

In summary, the beneficial effects of the optical imaging lens according to the embodiments of the invention are as follows. The optical imaging lens of the embodiments of the invention can provide a lens with a larger aperture, a larger image height, high resolution, and favorable image quality by satisfying the quantity, the surface shape, and the refracting power of the lenses required and by meeting the conditions.

In order to make the features and advantages of the invention comprehensible, embodiments accompanied with drawings are described in detail below.

### BRIEF DESCRIPTION OF THE DRAWING

FIG. 1 is a schematic view illustrating a surface structure of a lens.

FIG. 2 is a schematic view illustrating a concave-convex surface structure and a light focal point of a lens.

FIG. 3 is a schematic view illustrating a surface structure of a lens of an example 1.

FIG. 4 is a schematic view illustrating a surface structure of a lens of an example 2.

FIG. 5 is a schematic view illustrating a surface structure of a lens of an example 3.

FIG. 6 is a schematic view of an optical imaging lens according to a first embodiment of the invention.

FIG. 7A to FIG. 7D are diagrams of longitudinal spherical aberration and various aberrations of the optical imaging lens of the first embodiment.

FIG. 8 illustrates detailed optical data of the optical imaging lens of the first embodiment of the invention.

FIG. 9 illustrates aspheric parameters of the optical imaging lens according to the first embodiment of the invention.

FIG. 10 is a schematic view of an optical imaging lens according to a second embodiment of the invention.

FIG. 11A to FIG. 11D are diagrams of longitudinal spherical aberration and various aberrations of the optical imaging lens of the second embodiment.

FIG. 12 illustrates detailed optical data of the optical imaging lens of the second embodiment of the invention.

FIG. 13 illustrates aspheric parameters of the optical imaging lens according to the second embodiment of the invention.

FIG. 14 is a schematic view of an optical imaging lens according to a third embodiment of the invention.

FIG. 15A to FIG. 15D are diagrams of longitudinal spherical aberration and various aberrations of the optical imaging lens of the third embodiment.

FIG. 16 illustrates detailed optical data of the optical imaging lens of the third embodiment of the invention.

FIG. 17 illustrates aspheric parameters of the optical imaging lens according to the third embodiment of the invention.

FIG. 18 is a schematic view of an optical imaging lens according to a fourth embodiment of the invention.

FIG. 19A to FIG. 19D are diagrams of longitudinal spherical aberration and various aberrations of the optical imaging lens of the fourth embodiment.

FIG. 20 illustrates detailed optical data of the optical imaging lens of the fourth embodiment of the invention.

FIG. 21 illustrates aspheric parameters of the optical imaging lens according to the fourth embodiment of the invention.

FIG. 22 is a schematic view of an optical imaging lens according to a fifth embodiment of the invention.

FIG. 23A to FIG. 23D are diagrams of longitudinal spherical aberration and various aberrations of the optical imaging lens of the fifth embodiment.

FIG. 24 illustrates detailed optical data of the optical imaging lens of the fifth embodiment of the invention.

FIG. 25 illustrates aspheric parameters of the optical imaging lens according to the fifth embodiment of the invention.

FIG. 26 is a schematic view of an optical imaging lens according to a sixth embodiment of the invention.

FIG. 27A to FIG. 27D are diagrams of longitudinal spherical aberration and various aberrations of the optical imaging lens of the sixth embodiment.

FIG. 28 illustrates detailed optical data of the optical imaging lens of the sixth embodiment of the invention.

FIG. 29 illustrates aspheric parameters of the optical imaging lens according to the sixth embodiment of the invention.

FIG. 30 is a schematic view of an optical imaging lens according to a seventh embodiment of the invention.

FIG. 31A to FIG. 31D are diagrams of longitudinal spherical aberration and various aberrations of the optical imaging lens of the seventh embodiment.

FIG. 32 illustrates detailed optical data of the optical imaging lens of the seventh embodiment of the invention.

FIG. 33 illustrates aspheric parameters of the optical imaging lens according to the seventh embodiment of the invention.

FIG. 34 is a schematic view of an optical imaging lens according to an eighth embodiment of the invention.

FIG. 35A to FIG. 35D are diagrams of longitudinal spherical aberration and various aberrations of the optical imaging lens of the eighth embodiment.

FIG. 36 illustrates detailed optical data of the optical imaging lens of the eighth embodiment of the invention.

FIG. 37 illustrates aspheric parameters of the optical imaging lens according to the eighth embodiment of the invention.

FIG. 38 to FIG. 39 illustrate the important parameters and the numerical values of the conditions of the optical imaging lenses according to the first embodiment to the eighth embodiment of the invention.

### DESCRIPTION OF THE EMBODIMENTS

The terms “optical axis region”, “periphery region”, “concave”, and “convex” used in this specification and claims should be interpreted based on the definition listed in the specification by the principle of lexicographer.

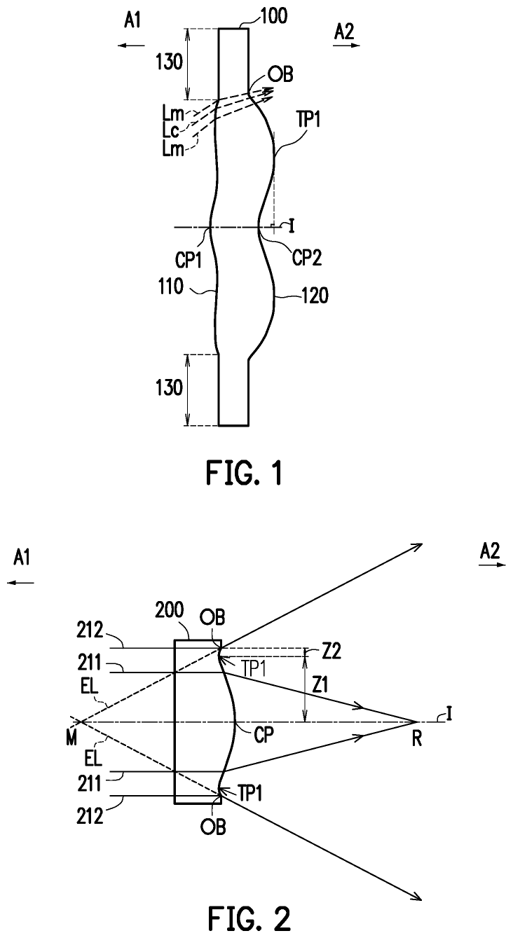

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex- (concave-) region,” can be used alternatively.

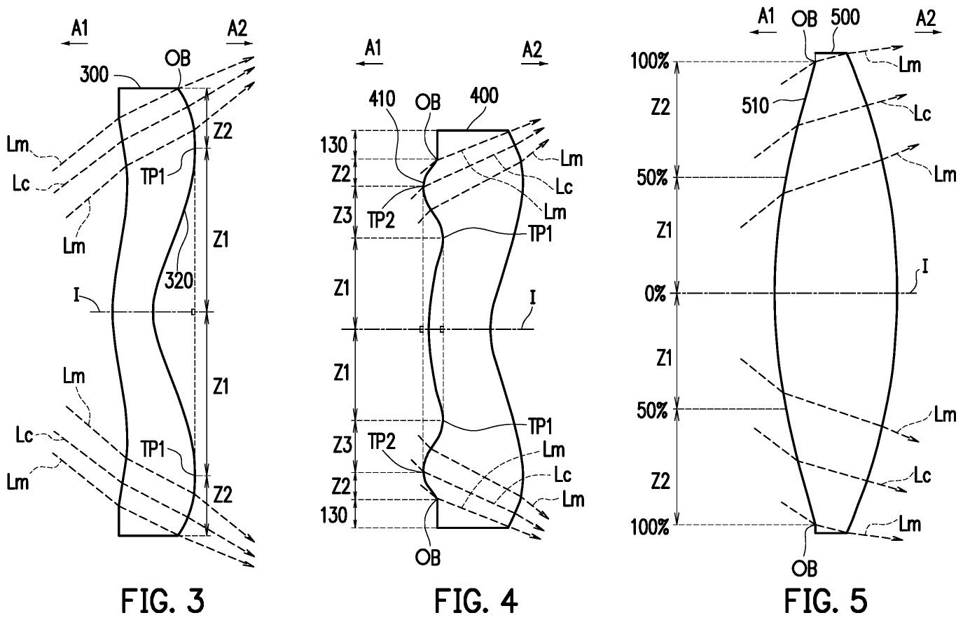

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

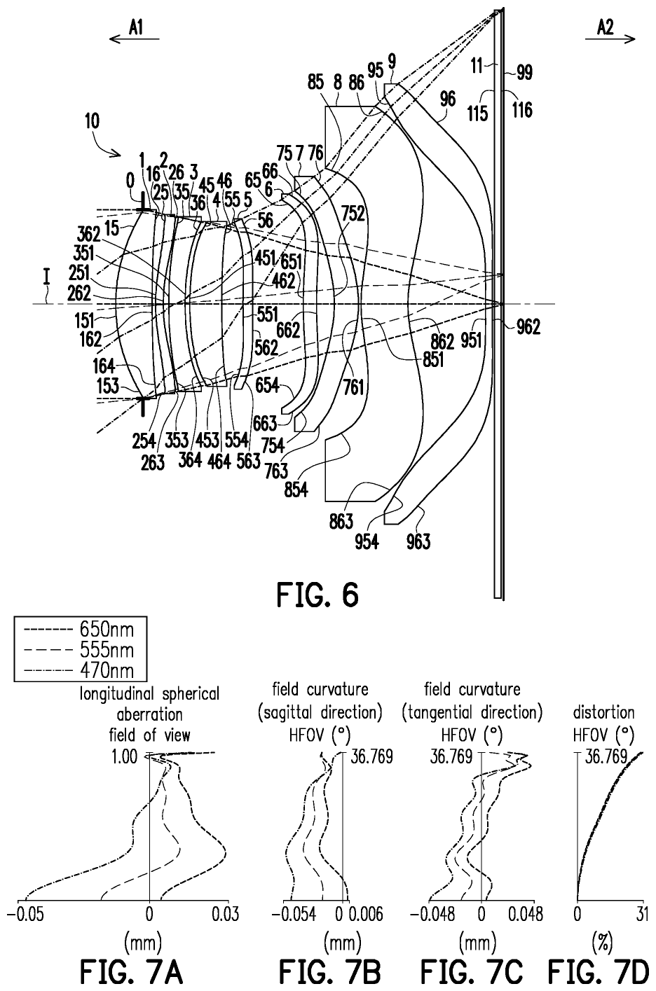

FIG. 6 is a schematic view of an optical imaging lens according to a first embodiment of the invention. FIG. 7A to FIG. 7D are diagrams of longitudinal spherical aberration and various aberrations of the optical imaging lens of the first embodiment. Referring to FIG. 6 first, an optical imaging lens 10 of the first embodiment of the invention includes an aperture 0, a first lens element 1, a second lens element 2, a third lens element 3, a fourth lens element 4, a fifth lens element 5, a sixth lens element 6, a seventh lens element 7, an eighth lens element 8, a ninth lens element 9, and a filter 11 disposed in sequence from an object side A1 to an image side A2 along an optical axis I of the optical imaging lens 10. When light emitted by an object to be photographed enters the optical imaging lens 10 and sequentially passes through the aperture 0, the first lens element 1, the second lens element 2, the third lens element 3, the fourth lens element 4, the fifth lens element 5, the sixth lens element 6, the seventh lens element 7, the eighth lens element 8, the ninth lens element 9, and filter 11, an image is produced on an image plane 99. It is supplemented that the object side A1 is a side facing the object to be photographed, and the image side A2 is a side facing the image plane 99.

In the embodiment, the first lens element 1, the second lens element 2, the third lens element 3, the fourth lens element 4, the fifth lens element 5, the sixth lens element 6, the seventh lens element 7, the eighth lens element 8, the ninth lens element 9, and the filter 11 each have object-side surfaces 15, 25, 35, 45, 55, 65, 75, 85, 95, 115 facing the object side A1 and allowing the imaging ray to pass through and image-side surfaces 16, 26, 36, 46, 56, 66, 76, 86, 96, 116 facing the image side A2 and allowing the imaging ray to pass through. In the embodiment, the aperture 0 is disposed on a side of the first lens element 1 facing the object side A1. The filter 11 is disposed between the image-side surface 96 and the image plane 99 of the ninth lens element 9. The filter 11 is an infrared (IR) cut filter, which can allow light with other wavelengths to pass through and block light with infrared wavelengths, but the invention is not limited thereto.

The first lens element 1 has positive refracting power. The material of the first lens element 1 is plastic, but the invention is not limited thereto. An optical axis region 151 of the object-side surface 15 of the first lens element 1 is convex, and a periphery region 153 thereof is convex. An optical axis region 162 of the image-side surface 16 of the first lens element 1 is concave, and a periphery region 164 thereof is concave. In the embodiment, both the object-side surface 15 and the image-side surface 16 of the first lens element 1 are aspheric.

The second lens element 2 has negative refracting power. The material of the second lens element 2 is plastic, but the invention is not limited thereto. An optical axis region 251 of the object-side surface 25 of the second lens element 2 is convex, and a periphery region 254 thereof is concave. An optical axis region 262 of the image-side surface 26 of the second lens element 2 is concave, and a periphery region 263 thereof is convex. In the embodiment, both the object-side surface 25 and the image-side surface 26 of the second lens element 2 are aspheric.

The third lens element 3 has negative refracting power. The material of the third lens element 3 is plastic, but the invention is not limited thereto. An optical axis region 351 of the object-side surface 35 of the third lens element 3 is convex, and a periphery region 353 thereof is convex. An optical axis region 362 of the image-side surface 36 of the third lens element 3 is concave, and a periphery region 364 thereof is concave. In the embodiment, both the object-side surface 35 and the image-side surface 36 of the third lens element 3 are aspheric.

The fourth lens element 4 has positive refracting power. The material of the fourth lens element 4 is plastic, but the invention is not limited thereto. An optical axis region 451 of the object-side surface 45 of the fourth lens element 4 is convex, and a periphery region 453 thereof is convex. An optical axis region 462 of the image-side surface 46 of the fourth lens element 4 is concave, and a periphery region 464 thereof is concave. In the embodiment, both the object-side surface 45 and the image-side surface 46 of the fourth lens element 4 are aspheric.

The fifth lens element 5 has positive refracting power. The material of the fifth lens element 5 is plastic, but the invention is not limited thereto. An optical axis region 551 of the object-side surface 55 of the fifth lens element 5 is convex, and a periphery region 554 thereof is concave. An optical axis region 562 of the image-side surface 56 of the fifth lens element 5 is concave, and a periphery region 563 thereof is convex. In the embodiment, both the object-side 55 and the image-side surface 56 of the fifth lens element 5 are aspheric.

The sixth lens element 6 has positive refracting power. The material of the sixth lens element 6 is plastic, but the invention is not limited thereto. An optical axis region 651 of the object-side surface 65 of the sixth lens element 6 is convex, and a periphery region 654 thereof is concave. An optical axis region 662 of the image-side surface 66 of the sixth lens element 6 is concave, and a periphery region 663 thereof is convex. In the embodiment, both the object-side surface 65 and the image-side surface 66 of the sixth lens element 6 are aspheric.

The seventh lens element 7 has positive refracting power. The material of the seventh lens element 7 is plastic, but the invention is not limited thereto. An optical axis region 752 of the object-side surface 75 of the seventh lens element 7 is concave, and a periphery region 754 thereof is concave. An optical axis region 761 of the image-side surface 76 of the seventh lens element 7 is convex, and a periphery region 763 thereof is convex. In the embodiment, both the object-side surface 75 and the image-side surface 76 of the seventh lens element 7 are aspheric.

The eighth lens element 8 has positive refracting power. The material of the eighth lens element 8 is plastic, but the invention is not limited thereto. An optical axis region 851 of the object-side surface 85 of the eighth lens element 8 is convex, and a periphery region 854 thereof is concave. An optical axis region 862 of the image-side surface 86 of the eighth lens element 8 is concave, and a periphery region 863 thereof is convex. In the embodiment, both the object-side surface 85 and the image-side surface 86 of the eighth lens element 8 are aspheric.

The ninth lens element 9 has positive refracting power. The material of the ninth lens element 9 is plastic, but the invention is not limited thereto. An optical axis region 951 of the object-side surface 95 of the ninth lens element 9 is convex, and a periphery region 954 thereof is concave. An optical axis region 962 of the image-side surface 96 of the ninth lens element 9 is concave, and a periphery region 963 thereof is convex. In the embodiment, both the object-side surface 95 and the image-side surface 96 of the ninth lens element 9 are aspheric.

In the embodiment, the lenses of the optical imaging lens 10 are only the first lens element 1, the second lens element 2, the third lens element 3, the fourth lens element 4, the fifth lens element 5, the sixth lens element 6, the seventh lens element 7, and the eighth lens element Lens 8 and ninth lens element 9, a total of nine lens elements.

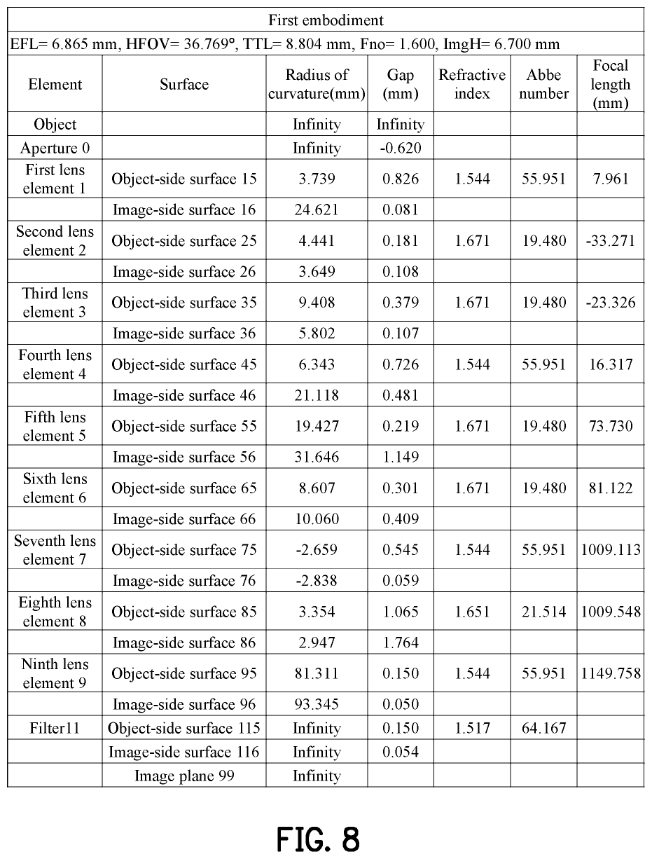

Other detailed optical data of the first embodiment is illustrated in FIG. 8. The effective focal length (EFL) of the optical imaging lens 10 of the first embodiment is 6.865 millimeters (mm), the half field of view (HFOV) is 36.769 degrees, the system length (TTL) is 8.804 mm, the F-number (Fno) is 1.600, the image height (ImgH) is 6.700 mm, and the system length refers to the distance from the object-side surface 15 of the first lens element 1 to the image plane 99 on the optical axis I.

In addition, in the embodiment, all the object-side surfaces 15, 25, 35, 45, 55, 65, 75, 85, 95 and the image-side surfaces 16, 26, 36, 46, 56, 66, 76, 86, 96 of the first lens element 1, the second lens element 2, the third lens element 3, the fourth lens element 4, the fifth lens element 5, the sixth lens element 6, the seventh lens element 7, the eighth lens element 8, and the ninth lens element 9 are aspheric, and the aspheric surfaces are defined according to the formula as follows.

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

where

Y: a vertical distance between a point on the aspheric surface and the optical axis I;

Z: the depth of the aspheric surface (the vertical distance between the point on the aspheric surface with the distance Y from the optical axis I and the tangent plane to the vertex on the optical axis I of the aspheric surface);

R: the radius of curvature of the lens surface near the optical axis I;

K: a conic constant;

aᵢ: an i-th order aspheric coefficient.

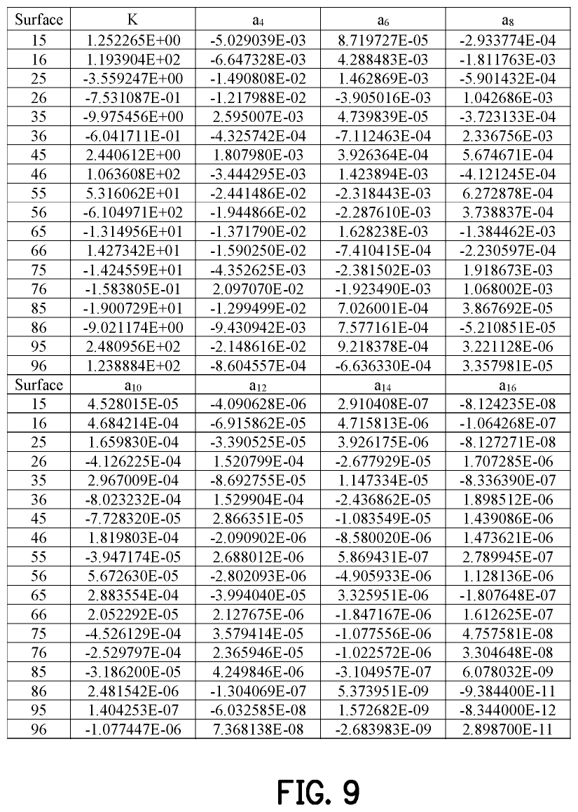

The various aspheric coefficients of the object-side surface 15 of the first lens element 1 to the image-side surface 96 of the ninth lens element 9 in the formula (1) are shown in FIG. 9. The column number 15 in FIG. 9 refers to the aspheric coefficient of the object-side surface 15 of the first lens element 1, and it can be analogically reasoned for the other columns. In addition, the odd-order aspheric coefficients (e.g., a₁, a₃, as, a₇, etc.) and the second-order aspheric coefficients (a₂) not listed in the table of FIG. 9 and the tables of the embodiments are all 0.

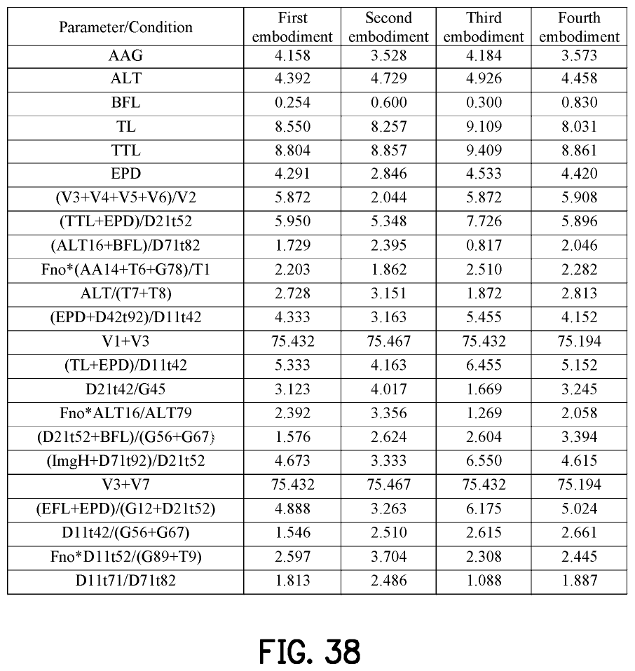

In addition, the relationship among the important parameters in the optical imaging lens 10 of the first embodiment is shown in FIG. 38, and in FIG. 38, the unit of each parameter from the AAG column to the EPD column is millimeter (mm).

In the figure,

T1 is the thickness of the first lens element 1 on the optical axis I;

T2 is the thickness of the second lens element 2 on the optical axis I;

T3 is the thickness of the third lens element 3 on the optical axis I;

T4 is the thickness of the fourth lens element 4 on the optical axis I;

T5 is the thickness of the fifth lens element 5 on the optical axis I;

T6 is the thickness of the sixth lens element 6 on the optical axis I;

T7 is the thickness of the seventh lens element 7 on the optical axis I;

T8 is the thickness of the eighth lens element 8 on the optical axis I;

T9 is the thickness of the ninth lens element 9 on the optical axis I;

G12 is the air gap between the first lens element 1 and the second lens element 2 on the optical axis I and also the distance from the image side 16 of the first lens element 1 to the object-side surface 25 of the second lens element 2 on the optical axis I;

G23 is the air gap between the second lens element 2 and the third lens element 3 on the optical axis I and also the distance from the image-side surface 26 of the second lens element 2 to the object-side surface 35 of the third lens element 3 on the optical axis I;

G34 is the air gap between the third lens element 3 and the fourth lens element 4 on the optical axis I and also the distance from the image-side surface 36 of the third lens element 3 to the object-side surface 45 of the fourth lens element 4 on the optical axis I;

G45 is the air gap between the fourth lens element 4 and the fifth lens element 5 on the optical axis I and also the distance from the image-side surface 46 of the fourth lens element 4 to the object-side 55 of the fifth lens element 5 on the optical axis I; G56 is the air gap between the fifth lens element 5 and the sixth lens element 6 on the optical axis I and also the distance from the image-side surface 56 of the fifth lens element 5 to the object-side surface 65 of the sixth lens element 6 on the optical axis I;

G67 is the air gap between the sixth lens element 6 and the seventh lens element 7 on the optical axis I and also the distance from the image-side surface 66 of the sixth lens element 6 to the object-side surface 75 of the seventh lens element 7 on the optical axis I;

G78 is the air gap between the seventh lens element 7 and the eighth lens element 8 on the optical axis I and also the distance from the image-side surface 76 of the seventh lens element 7 to the object-side surface 85 of the eighth lens element 8 on the optical axis I;

G89 is the air gap between the eighth lens element 8 and the ninth lens element 9 on the optical axis I and also the distance from the image-side surface 86 of the eighth lens element 8 to the object-side surface 95 of the ninth lens element 9 on the optical axis I;

AAG is the sum of the eight air gaps of the first lens element 1 to the ninth lens element 9 on the optical axis I, that is, the sum of G12, G23, G34, G45, G56, G67, G78, and G89;

ALT is the sum of the nine thicknesses of the first lens element 1 to the ninth lens element 9 on the optical axis I, that is, the sum of T1, T2, T3, T4, T5, T6, T7, T8, and T9;

TL is the distance from the object-side surface 15 of the first lens element 1 to the image-side surface 96 of the ninth lens element 9 on the optical axis I;

TTL is the distance from the object-side surface 15 of the first lens element 1 to the image plane 99 on the optical axis I; BFL is the distance from the image-side surface 96 of the ninth lens element 9 to the image plane 99 on the optical axis I;

AA14 is the sum of the four air gaps of the first lens element 1 to the fifth lens element 5 on the optical axis I, that is, the sum of G12, G23, G34, and G45;

ALT16 is the sum of the six thicknesses of the first lens element 1 to the sixth lens element 6 on the optical axis I, that is, the sum of T1, T2, T3, T4, T5, and T6;

ALT79 is the sum of the three thicknesses of the seventh lens element 7 to the ninth lens element 9 on the optical axis I, that is, the sum of T7, T8, and T9;

D21t52 is the distance from the object-side surface 25 of the second lens element 2 to the image-side surface 56 of the fifth lens element 5 on the optical axis I;

D71t82 is the distance from the object-side surface 75 of the seventh lens element 7 to the image-side surface 86 of the eighth lens element 8 on the optical axis I;

D42t92 is the distance from the image-side surface 46 of the fourth lens element 4 to the image-side surface 96 of the ninth lens element 9 on the optical axis I;

D11t42 is the distance from the object-side surface 15 of the first lens element 1 to the image-side surface 46 of the fourth lens element 4 on the optical axis I;

D21t42 is the distance from the object-side surface 25 of the second lens element 2 to the image-side surface 46 of the fourth lens element 4 on the optical axis I;

D71t92 is the distance from the object-side surface 75 of the seventh lens element 7 to the image-side surface 96 of the ninth lens element 9 on the optical axis I;

D11t71 is the distance from the object-side surface 15 of the first lens element 1 to the object-side surface 75 of the seventh lens element 7 on the optical axis I;

D11t52 is the distance from the object-side surface 15 of the first lens element 1 to the image-side surface 56 of the fifth lens element 5 on the optical axis I;

HFOV is the half field of view of the optical imaging lens 10; Fno is the F-number of the optical imaging lens 10;

ImgH is the image height of the optical imaging lens 10; and EFL is the effective focal length of the optical imaging lens 10.

EPD is the entrance pupil diameter of the optical imaging lens 10, that is, the effective focal length of the optical imaging lens 10 divided by the F-number;

Also, the following is further defined:

G9F is the air gap between the ninth lens element 9 and the filter 11 on the optical axis I and also the distance from the image-side surface 96 of the ninth lens element 9 to the object-side surface 115 of the filter 11 on the optical axis I;

TF is the thickness of the filter 11 on the optical axis I;

GFP is the air gap between the filter 11 and the image plane 99 on the optical axis I and also the distance from the image-side surface 116 of the filter 11 to the image plane 99 on the optical axis I;

f1 is the focal length of the first lens element 1;

f2 is the focal length of the second lens element 2;

f3 is the focal length of the third lens element 3;

f4 is the focal length of the fourth lens element 4;

f5 is the focal length of the fifth lens element 5;

f6 is the focal length of the sixth lens element 6;

f7 is the focal length of the seventh lens element 7;

f8 is the focal length of the eighth lens element 8;

f9 is the focal length of the ninth lens element 9;

n1 is the refractive index of the first lens element 1;

n2 is the refractive index of the second lens element 2;

n3 is the refractive index of the third lens element 3;

n4 is the refractive index of the fourth lens element 4;

n5 is the refractive index of the fifth lens element 5;

n6 is the refractive index of the sixth lens element 6;

n7 is the refractive index of the seventh lens element 7;

n8 is the refractive index of the eighth lens element 8;

n9 is the refractive index of the ninth lens element 9;

V1 is the Abbe number of the first lens element 1;

V2 is the Abbe number of the second lens element 2;

V3 is the Abbe number of the third lens element 3;

V4 is the Abbe number of the fourth lens element 4;

V5 is the Abbe number of the fifth lens element 5;

V6 is the Abbe number of the sixth lens element 6;

V7 is the Abbe number of the seventh lens element 7;

V8 is the Abbe number of the eighth lens element 8; and

V9 is the Abbe number of the ninth lens element 9.

Referring to FIG. 7A to FIG. 7D again, FIG. 7A illustrates the longitudinal spherical aberration of the first embodiment; FIG. 7B and FIG. 7C illustrate the field curvature aberration in the Sagittal direction and the field curvature aberration in the tangential direction on the image plane 99 when the wavelengths of the first embodiment are 470 nanometers (nm), 555 nm, and 650 nm, respectively; and FIG. 7D illustrates the distortion aberration on the image plane 99 when the wavelengths of the first embodiment are 470 nm, 555 nm, and 650 nm. In FIG. 7A illustrating the longitudinal spherical aberration diagram of the first embodiment, the curves formed by each wavelength are very close and approach to the middle, this illustrates that the off-axis rays of each wavelength and with different heights are concentrated near the imaging point, and according to the skew amplitude of the curve of each wavelength, the deviation of the imaging point of the off-axis light with different heights is controlled within the range of ±0.05 mm, so the first embodiment does significantly improve the spherical aberration of the same wavelength. In addition, the distances among the three representative wavelengths are quite close to one another, and the imaging positions representing the light of different wavelengths are quite concentrated, so the chromatic aberration is also significantly improved.

In the two field curvature aberration diagrams shown in FIG. 7B and FIG. 7C, the field curvature aberrations of the three representative wavelengths in the entire field of view are within ±0.054 mm, and this means that the optical system of the first embodiment can effectively eliminate the aberrations. In FIG. 7D illustrating the distortion aberration, the distortion aberration of the first embodiment is maintained within the range of ±31%, and this means that the distortion aberration of the first embodiment can meet the imaging quality requirements of the optical system. Accordingly, compared with the existing optical imaging lens, under the condition that the system length is about 8.804 mm, the optical imaging lens of the first embodiment can provide a F-number of 1.600 and an image height of 6.700 mm and can provide good imaging quality and chromatic aberration performance.

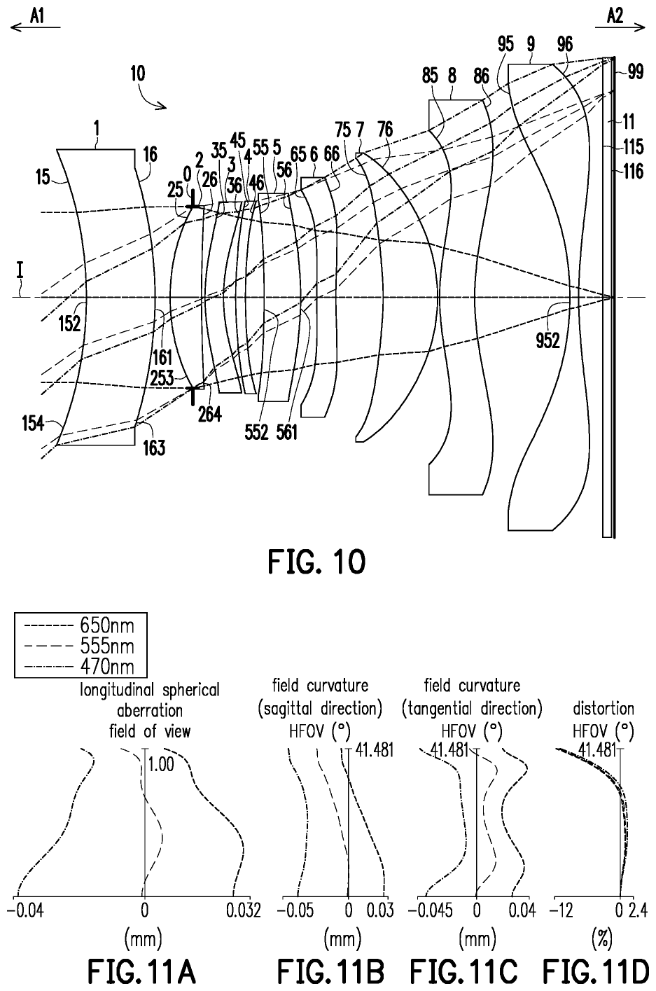

FIG. 10 is a schematic view of an optical imaging lens according to a second embodiment of the invention, and FIG. 11A to FIG. 11D are diagrams of longitudinal spherical aberration and various aberrations of the optical imaging lens of the second embodiment. Referring to FIG. 10 first, the optical imaging lens 10 of the second embodiment of the invention is substantially similar to that of the first embodiment, and what differs is as follows. Each optical data, aspheric coefficient, and lenses 1, 2, 3, 4, 5, 6, 7, 8 and 9 have more or less different parameters. In addition, in the embodiment, the first lens element 1 has negative refracting power, the second lens element 2 has positive refracting power, the sixth lens element 6 has negative refracting power, the ninth lens element 9 has negative refracting power, the optical axis region 152 of the object-side surface 15 of the first lens element 1 is concave, the periphery region 154 of the object-side surface 15 of the first lens element 1 is concave, the optical axis region 161 of the image-side surface 16 of the first lens element 1 is convex, the periphery region 163 of the image-side surface 16 of the first lens element 1 is convex, the periphery region 253 of the object-side surface 25 of the second lens element 2 is a convex, the periphery region 264 of the image-side surface 26 of the second lens element 2 is concave, the optical axis region 552 of the object-side surface 55 of the fifth lens element 5 is concave, the optical axis region 561 of the image-side surface 56 of the fifth lens element 5 is convex, and the optical axis region 952 of the object-side surface 95 of the ninth lens element 9 is concave. In addition, in the embodiment, the aperture 0 is disposed on the side of the second lens element 2 facing the object side A1. Note that to clearly display the drawings, the reference numerals of the optical axis region and the periphery region similar to those in the first embodiment are omitted in FIG. 10.

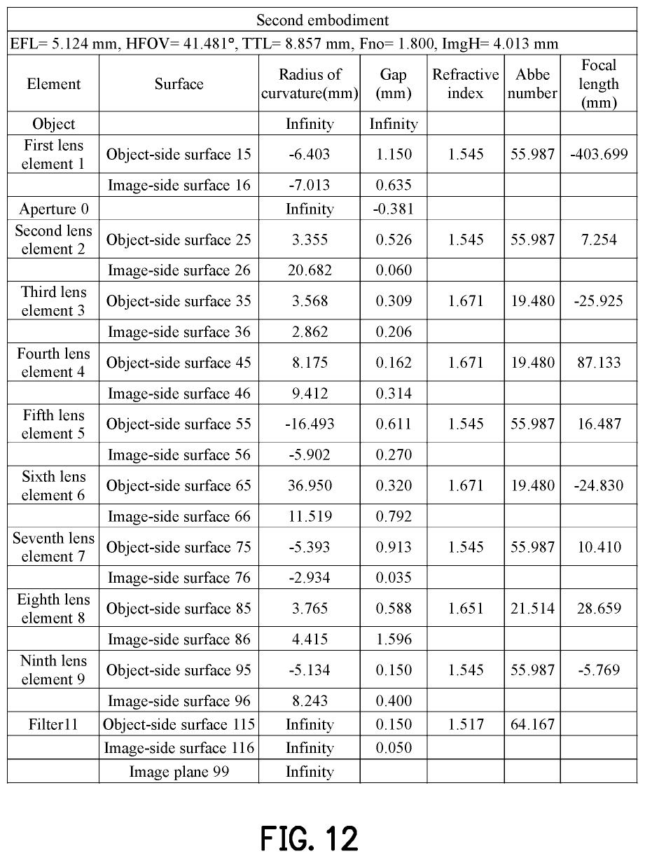

The detailed optical data of the optical imaging lens 10 of the second embodiment is shown in FIG. 12. In addition, the effective focal length (EFL) of the optical imaging lens 10 of the second embodiment is 5.124 mm, the half field of view (HFOV) is 41.481 degrees, the system length (TTL) is 8.857 mm, the F-number (Fno) is 1.800, and the image height (ImgH) is 4.013 mm.

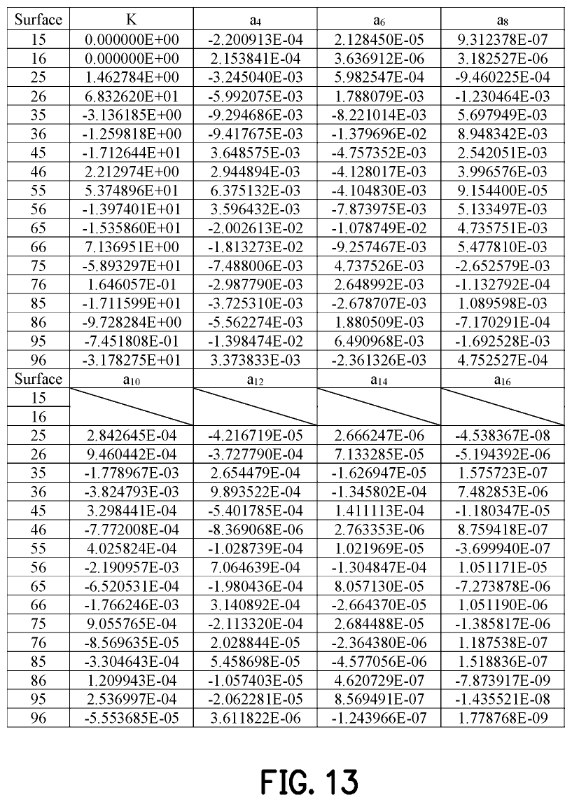

As shown in FIG. 13, the aspheric coefficients of the object-side surface 15 of the first lens element 1 to the image-side surface 96 of the ninth lens element 9 of the second embodiment in the formula (1) are illustrated.

In addition, the relationship among the important parameters in the optical imaging lens 10 of the second embodiment is shown in FIG. 38.

In FIG. 11A illustrating the longitudinal spherical aberration of the second embodiment, the deviation of the imaging point of off-axis rays of different heights is controlled within a range of ±0.04 mm. In the two field curvature aberration diagrams of FIG. 11B and FIG. 11C, the field curvature aberrations of the three representative wavelengths within the entire field of view fall within ±0.05 mm. The distortion aberration diagram of FIG. 11D illustrates that the distortion aberration of the second embodiment is maintained within the range of ±12%. Accordingly, compared with the existing optical imaging lens, under the condition that the system length is about 8.857 mm, the second embodiment may provide the F-number (Fno) of 1.800 and the image height of 4.013 mm and may provide good imaging quality and good chromatic aberration performance.

According to the foregoing description, compared with the first embodiment, the second embodiment has advantages as follows. The half field of view (HFOV) of the second embodiment is greater than that of the first embodiment, and the longitudinal aberration, field curvature aberration, and distortion aberration of the second embodiment outperform those of the first embodiment.

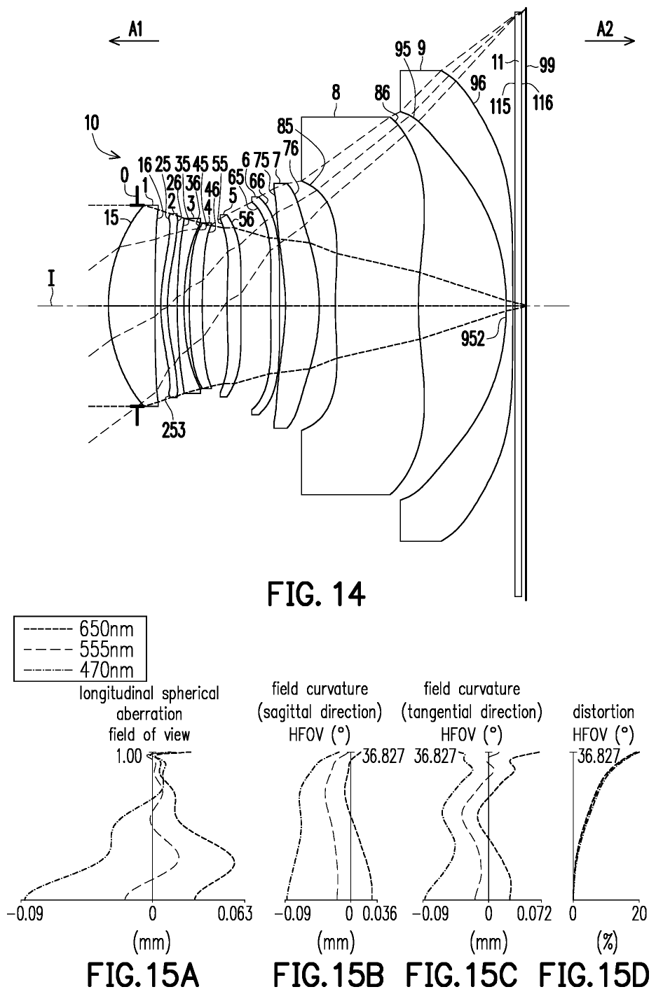

FIG. 14 is a schematic view of an optical imaging lens according to a third embodiment of the invention, and FIG. 15A to FIG. 15D are diagrams of longitudinal spherical aberration and various aberrations of the optical imaging lens of the third embodiment. Referring to FIG. 14 first, the optical imaging lens 10 of the third embodiment of the invention is substantially similar to that of the first embodiment, and what differs is illustrated as follows. Various optical data, aspheric coefficients, and the parameters of lens elements 1, 2, 3, 4, 5, 6, 7, 8 and 9 are more or less different. In addition, in the embodiment, the second lens element 2 has positive refracting power, the fourth lens element 4 has negative refracting power, the seventh lens element 7 has negative refracting power, the eighth lens element 8 has negative refracting power, the ninth lens element 9 has negative refracting power, the periphery region 253 of the object-side surface 25 of the second lens element 2 is convex, and the optical axis region 952 of the object-side surface 95 of the ninth lens element 9 is concave. Note that for the clarity of the drawing, the reference numerals of the optical axis region and the periphery region similar to those in the first embodiment are omitted in FIG. 14.

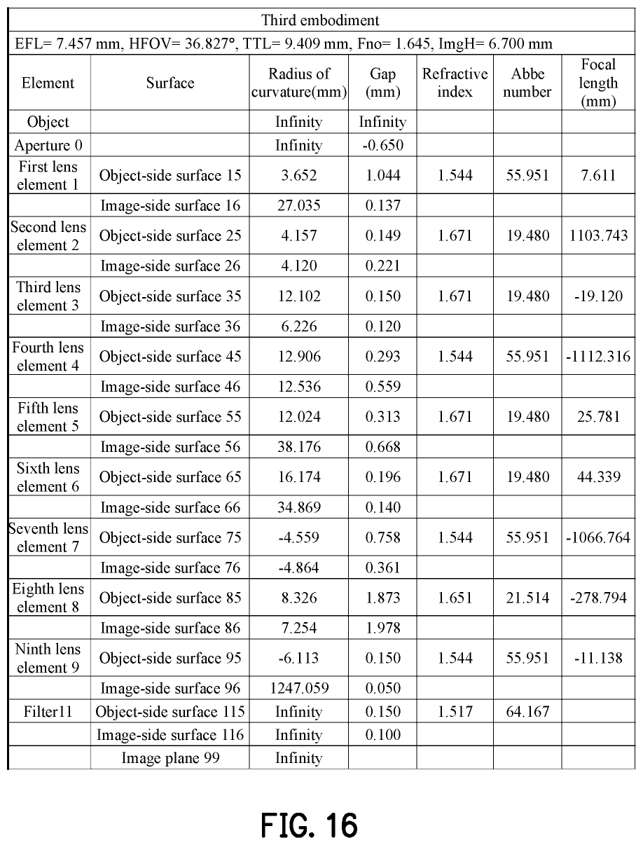

The detailed optical data of the optical imaging lens 10 of the third embodiment is shown in FIG. 16. In addition, the effective focal length (EFL) of the optical imaging lens 10 of the third embodiment is 7.457 mm, the half field of view (HFOV) is 36.827 degrees, the system length (TTL) is 9.409 mm, the F-number (Fno) is 1.645, and the image height (ImgH) is 6.700 mm.

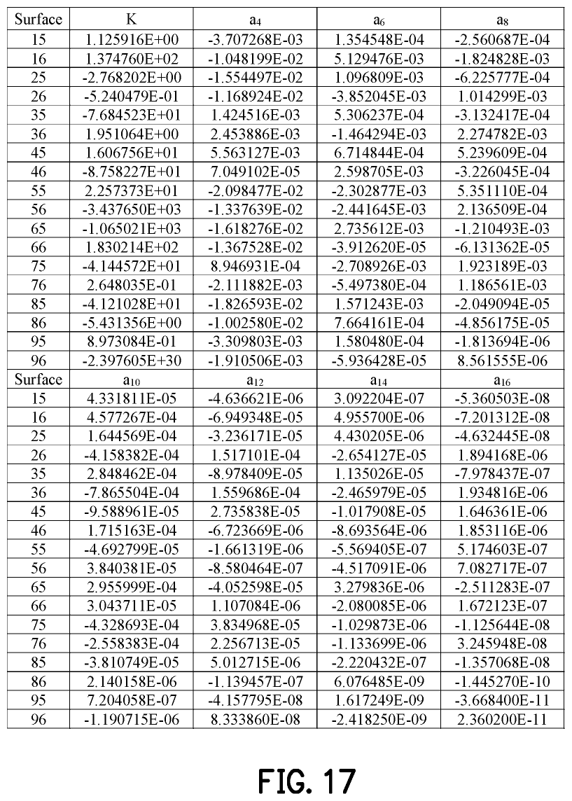

As shown in FIG. 17, the aspheric coefficients of the object-side surface 15 of the first lens element 1 to the image-side surface 96 of the ninth lens element 9 of the third embodiment in the formula (1) are illustrated.

In addition, the relationship among the important parameters in the optical imaging lens 10 of the third embodiment is shown in FIG. 38.

In FIG. 15A illustrating the longitudinal spherical aberration of the third embodiment, the deviation of the imaging point of off-axis rays of different heights is controlled within a range of ±0.09 mm. In the two field curvature aberration diagrams of FIG. 15B and FIG. 15C, the field curvature aberrations of the three representative wavelengths within the entire field of view fall within ±0.09 mm. The distortion aberration diagram of FIG. 15D illustrates that the distortion aberration of the third embodiment is maintained within the range of ±20%. Accordingly, compared with the existing optical imaging lens, under the condition that the system length is about 9.409 mm, the third embodiment may provide the F-number (Fno) of 1.645 and the image height of 6.700 mm and may provide good imaging quality and chromatic aberration performance.

According to the forgoing description, compared with the first embodiment, the third embodiment has advantages as follows. The half field of view (HFOV) of the third embodiment is greater than that of the first embodiment, and the distortion aberration of the third embodiment outperforms that of the first embodiment.

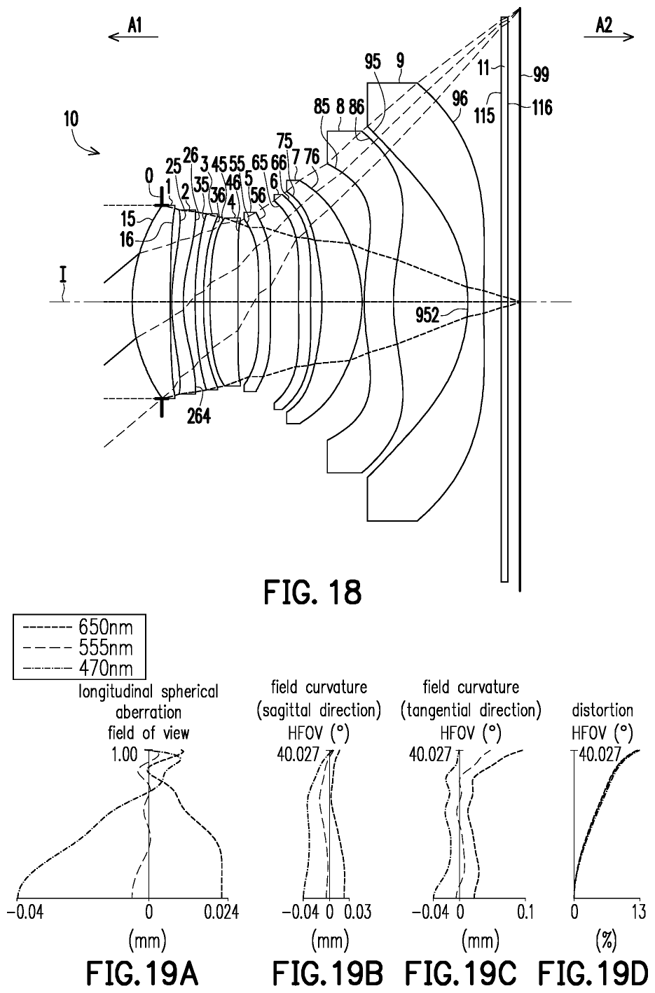

FIG. 18 is a schematic view of an optical imaging lens according to a fourth embodiment of the invention, and FIG. 19A to FIG. 19D are diagrams of longitudinal spherical aberration and various aberrations of the optical imaging lens of the fourth embodiment. Referring to FIG. 18 first, the optical imaging lens 10 of the fourth embodiment of the invention is substantially similar to that of the first embodiment, and what differs is illustrated as follows. Various optical data, aspheric coefficients, and the parameters of the lens elements 1, 2, 3, 4, 5, 6, 7, 8, and 9 are more or less different. In addition, in the embodiment, the third lens element 3 has positive refracting power, the fifth lens element 5 has negative refracting power, the eighth lens element 8 has negative refracting power, the ninth lens element 9 has negative refracting power, the periphery region 264 of the image-side surface 26 of the second lens element 2 is concave, and the optical axis region 952 of the object-side surface 95 of the ninth lens element 9 is concave. Note that for the clarity of the drawing, the reference numerals of the optical axis region and the periphery region similar to those in the first embodiment are omitted in FIG. 18.

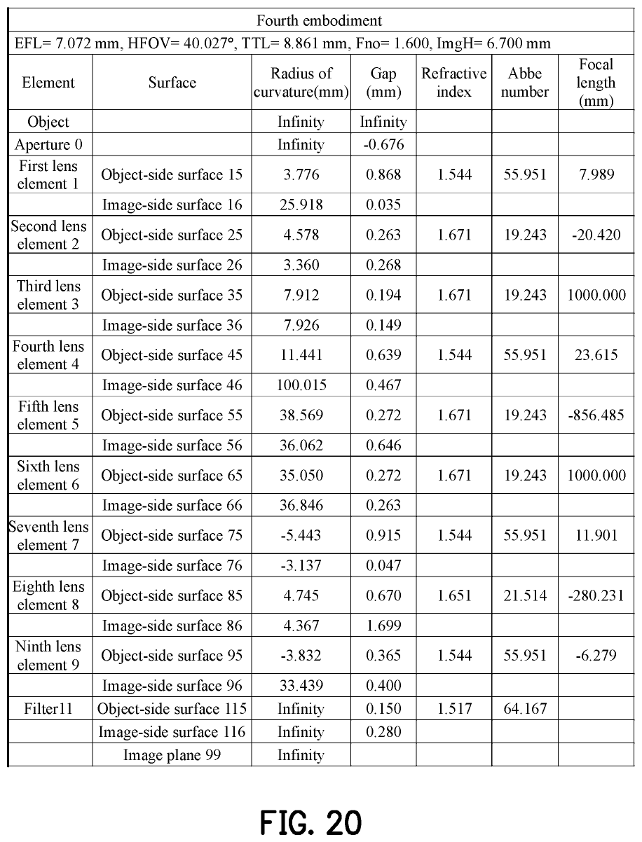

The detailed optical data of the optical imaging lens 10 of the fourth embodiment is shown in FIG. 20. In addition, the effective focal length (EFL) of the optical imaging lens 10 of the fourth embodiment is 7.072 mm, the half field of view (HFOV) is 40.027 degrees, the system length (TTL) is 8.861 mm, the F-number (Fno) is 1.600, and the image height (ImgH) is 6.700 mm.

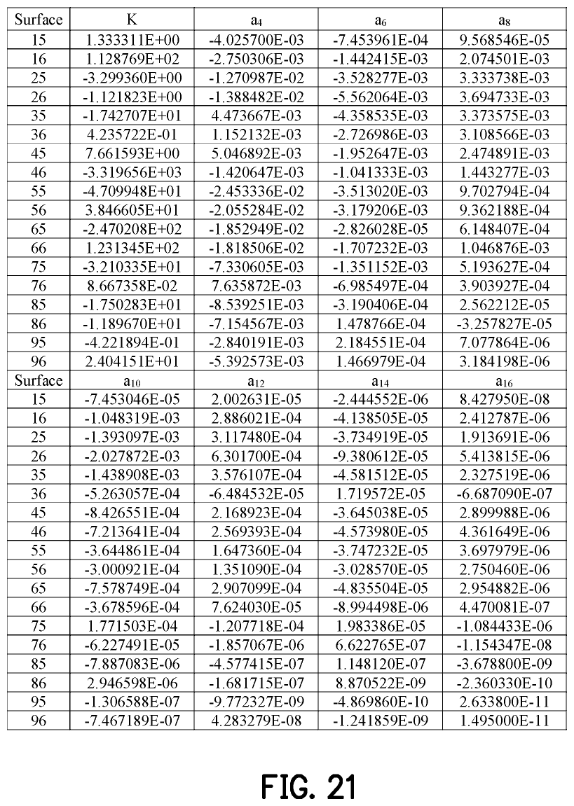

As shown in FIG. 21, the aspheric coefficients of the object-side surface 15 of the first lens element 1 to the image-side surface 96 of the ninth lens element 9 of the fourth embodiment in the formula (1) are illustrated.

In addition, the relationship among the important parameters in the optical imaging lens 10 of the fourth embodiment is shown in FIG. 38.

In FIG. 19A illustrating the longitudinal spherical aberration of the fourth embodiment, the deviation of the imaging point of off-axis rays of different heights is controlled within a range of ±0.04 mm. In the two field curvature aberration diagrams of FIG. 19B and FIG. 19C, the field curvature aberrations of the three representative wavelengths within the entire field of view fall within ±0.10 mm. The distortion aberration diagram of FIG. 19D illustrates that the distortion aberration of the fourth embodiment is maintained within the range of ±13%. Accordingly, compared with the existing optical imaging lens, under the condition that the system length is about 8.861 mm, the fourth embodiment may provide the F-number (Fno) of 1.600 and the image height of 6.700 mm and may provide good imaging quality and good chromatic aberration performance. According to the foregoing description, compared with the first embodiment, the fourth embodiment has advantages as follows. The half field of view (HFOV) of the fourth embodiment is greater than that of the first embodiment, and the longitudinal aberration and the distortion aberration of the fourth embodiment outperform those of the first embodiment.

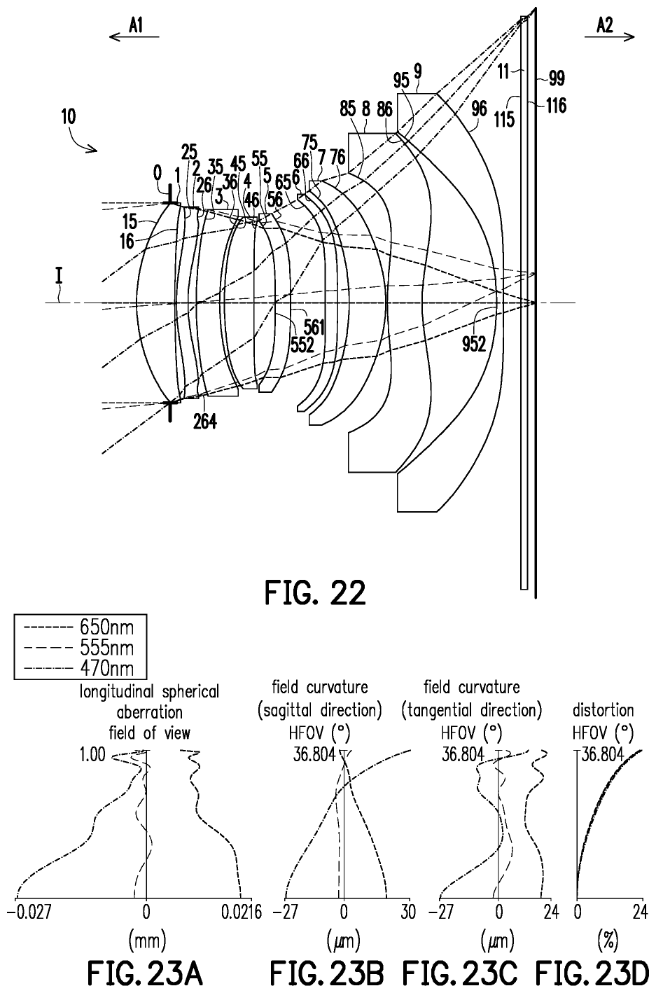

FIG. 22 is a schematic view of an optical imaging lens according to a fifth embodiment of the invention, and FIG. 23A to FIG. 23D are diagrams of longitudinal spherical aberration and various aberrations of the optical imaging lens of the fifth embodiment. Referring to FIG. 22 first, the optical imaging lens 10 of the fifth embodiment of the invention is substantially similar to that of the first embodiment, and what differs is illustrated as follows. Various optical data, aspheric coefficients, and the parameters of the lens elements 1, 2, 3, 4, 5, 6, 7, 8, and 9 are more or less different. In addition, in the embodiment, the eighth lens element 8 has negative refracting power, the ninth lens element 9 has negative refracting power, the periphery region 264 of the image-side surface 26 of the second lens element 2 is concave, the optical axis region 552 of the object-side surface 55 of the fifth lens element 5 is concave, the optical axis region 561 of the image-side surface 56 of the fifth lens element 5 is convex, and the optical axis region 952 of the object-side surface 95 of the ninth lens element 9 is concave. Meanwhile, note that for the clarity of the drawing, the reference numerals of the optical axis region and the periphery region similar to those in the first embodiment are omitted in FIG. 22.

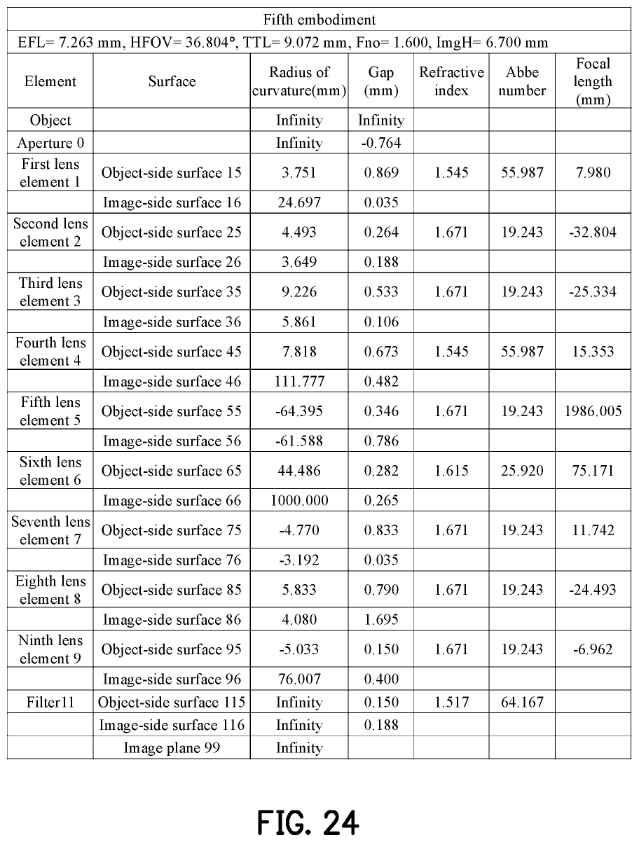

The detailed optical data of the optical imaging lens 10 of the fifth embodiment is shown in FIG. 24. In addition, the effective focal length (EFL) of the optical imaging lens 10 of the fifth embodiment is 7.263 mm, the half field of view (HFOV) is 36.804 degrees, the system length (TTL) is 9.072 mm, the F-number (Fno) is 1.600, and the image height (ImgH) is 6.700 mm.

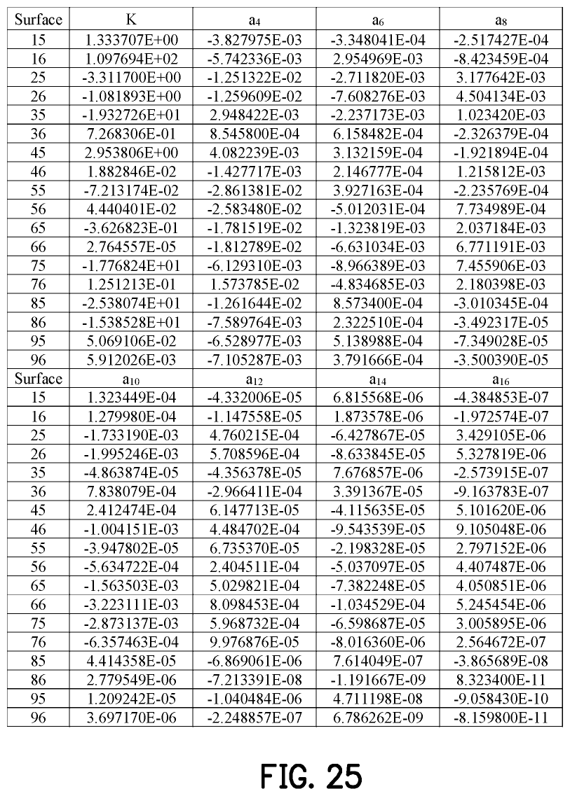

As shown in FIG. 25, the aspheric coefficients of the object-side surface 15 of the first lens element 1 to the image-side surface 96 of the ninth lens element 9 of the fifth embodiment in the formula (1) are illustrated.

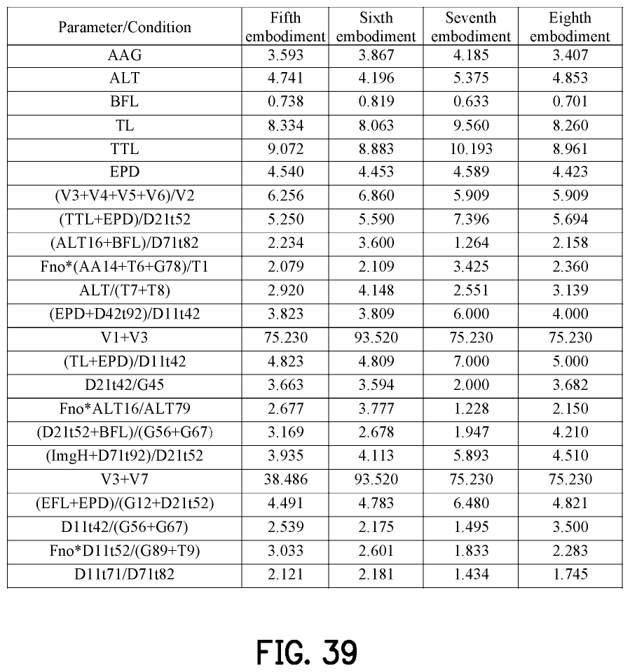

In addition, the relationship among the important parameters in the optical imaging lens 10 of the fifth embodiment is shown in FIG. 39.

In FIG. 23A illustrating the longitudinal spherical aberration of the fifth embodiment, the deviation of the imaging point of off-axis rays of different heights is controlled within a range of ±0.027 mm. In the two field curvature aberration diagrams of FIG. 23B and FIG. 23C, the field curvature aberrations of the three representative wavelengths within the entire field of view fall within ±30 micrometers (μm). The distortion aberration diagram of FIG. 23D illustrates that the distortion aberration of the fifth embodiment is maintained within the range of ±24%. Accordingly, compared with the existing optical imaging lens, under the condition that the system length is about 9.072 mm, the fifth embodiment may provide the F-number (Fno) of 1.600 and the image height of 6.700 mm and may provide good imaging quality and good chromatic aberration performance.

According to the foregoing description, compared with the first embodiment, the fifth embodiment has advantages as follows. The half field of view (HFOV) of the fifth embodiment is greater than that of the first embodiment, and the longitudinal aberration, the field curvature aberration, and the distortion aberration of the fifth embodiment outperform those of the first embodiment.

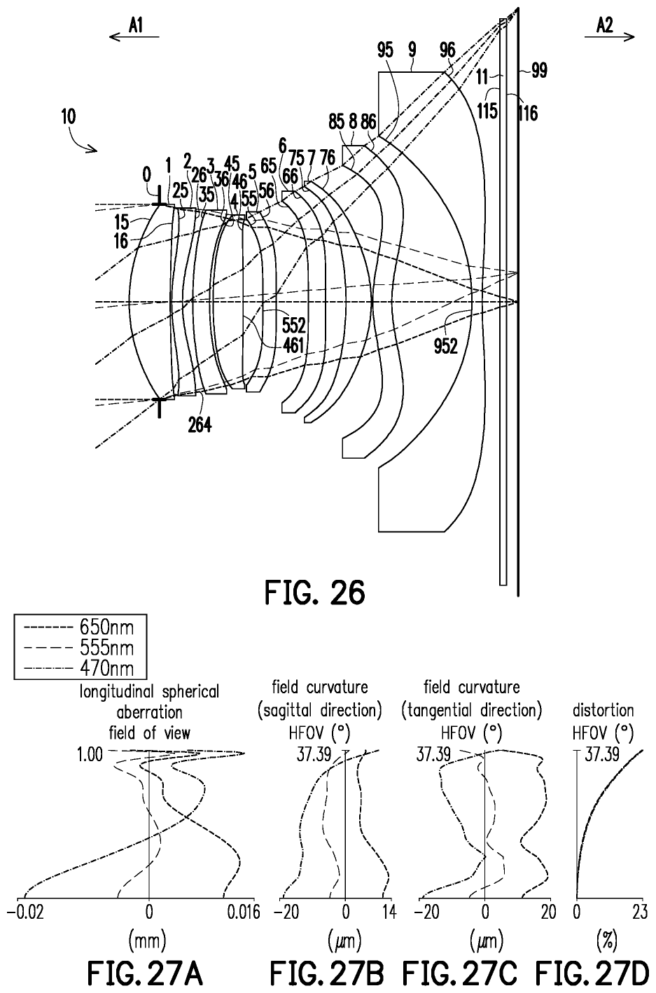

FIG. 26 is a schematic view of an optical imaging lens according to a sixth embodiment of the invention, and FIG. 27A to FIG. 27D are diagrams of longitudinal spherical aberration and various aberrations of the optical imaging lens of the sixth embodiment. Referring to FIG. 26 first, the optical imaging lens 10 of the sixth embodiment of the invention is substantially similar to that of the first embodiment, and what differs is illustrated as follows. Various optical data, aspheric coefficients, and the parameters of the lens elements 1, 2, 3, 4, 5, 6, 7, 8, and 9 are more or less different. In addition, in the embodiment, the fifth lens element 5 has negative refracting power, the sixth lens element 6 has negative refracting power, the eighth lens element 8 has negative refracting power, the ninth lens element 9 has negative refracting power, the periphery region 264 of the image-side surface 26 of the second lens element 2 is concave, the optical axis region 461 of the image-side surface 46 of the fourth lens element 4 is convex, the optical axis region 552 of the object-side surface 55 of the fifth lens element 5 is concave, and the optical axis region 952 of the object-side surface 95 of the ninth lens element 9 is concave. Meanwhile, note that for the clarity of the drawing, the reference numerals of the optical axis region and the periphery region similar to those in the first embodiment are omitted in FIG. 26.

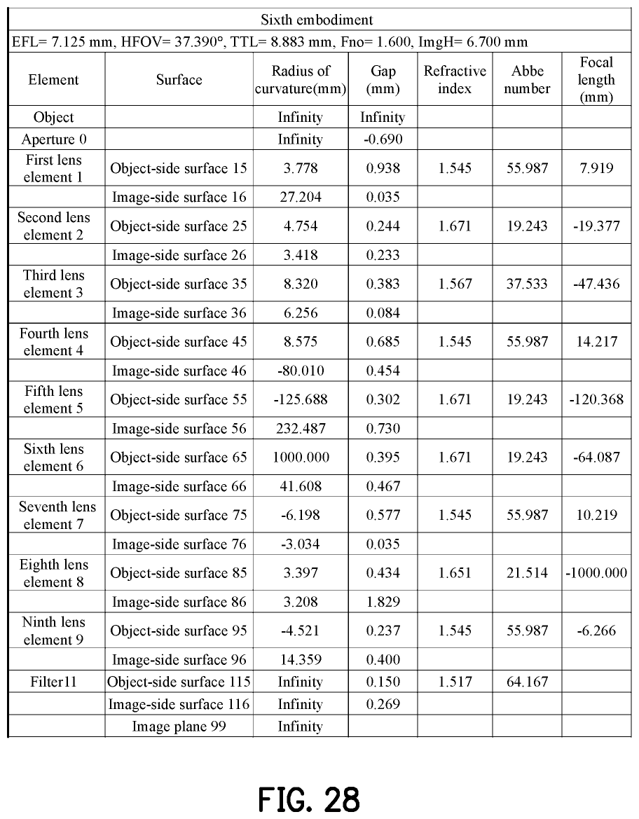

The detailed optical data of the optical imaging lens 10 of the sixth embodiment is shown in FIG. 28. In addition, the effective focal length (EFL) of the optical imaging lens 10 of the sixth embodiment is 7.125 mm, the half field of view (HFOV) is 37.390 degrees, the system length (TTL) is 8.883 mm, the F-number (Fno) is 1.600, and the image height (ImgH) is 6.700 mm.

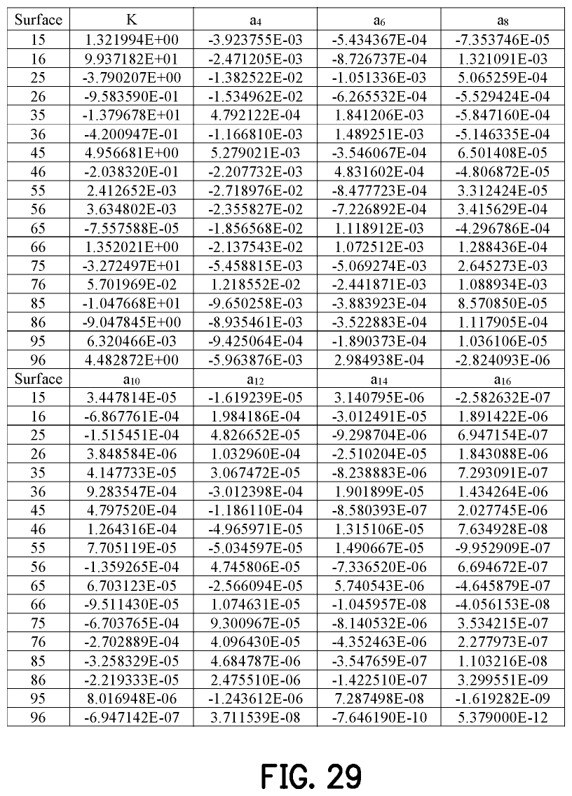

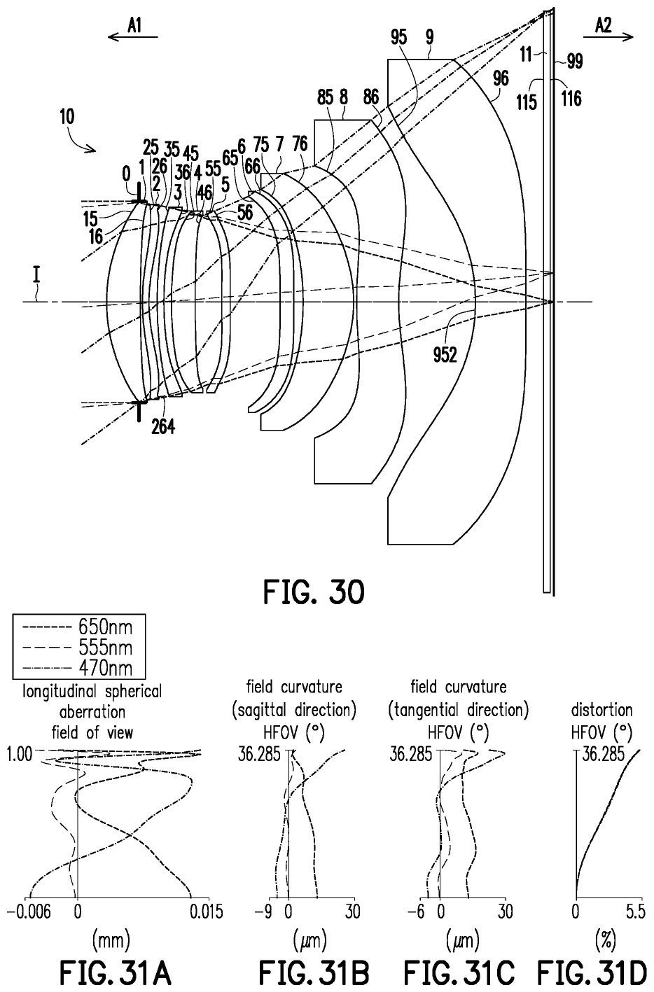

As shown in FIG. 29, the aspheric coefficients of the object-side surface 15 of the first lens element 1 to the image-side surface 96 of the ninth lens element 9 of the sixth embodiment in the formula (1) are illustrated.

In addition, the relationship among the important parameters in the optical imaging lens 10 of the sixth embodiment is shown in FIG. 39.

In FIG. 27A illustrating the longitudinal spherical aberration of the sixth embodiment, the deviation of the imaging point of off-axis rays of different heights is controlled within a range of ±0.02 mm. In the two field curvature aberration diagrams of FIG. 27B and FIG. 27C, the field curvature aberrations of the three representative wavelengths within the entire field of view fall within ±20 μm. The distortion aberration diagram of FIG. 27D illustrates that the distortion aberration of the sixth embodiment is maintained within the range of ±23%. Accordingly, compared with the existing optical imaging lens, under the condition that the system length is about 8.883 mm, the sixth embodiment may provide the F-number (Fno) of 1.600 and the image height of 6.700 mm and may provide good imaging quality and good chromatic aberration performance.

According to the foregoing description, compared with the first embodiment, the sixth embodiment has advantages as follows. The half field of view (HFOV) of the sixth embodiment is greater than that of the first embodiment, and the longitudinal aberration, the field curvature aberration, and the distortion aberration of the sixth embodiment outperform those of the first embodiment.

FIG. 30 is a schematic view of an optical imaging lens according to a seventh embodiment of the invention, and FIG. 31A to FIG. 31D are diagrams of longitudinal spherical aberration and various aberrations of the optical imaging lens of the seventh embodiment. Referring to FIG. 30 first, the optical imaging lens 10 of the seventh embodiment of the invention is substantially similar to that of the first embodiment, and what differs is illustrated as follows. Various optical data, aspheric coefficients, and the parameters of the lens elements 1, 2, 3, 4, 5, 6, 7, 8, and 9 are more or less different. In addition, in the embodiment, the sixth lens element 6 has negative refracting power, the eighth lens element 8 has negative refracting power, the ninth lens element 9 has negative refracting power, the periphery region 264 of the image-side surface 26 of the second lens element 2 is concave, and the optical axis region 952 of the object-side surface 95 of the ninth lens element 9 is concave. Meanwhile, note that for the clarity of the drawing, the reference numerals of the optical axis region and the periphery region similar to those in the first embodiment are omitted in FIG. 30.

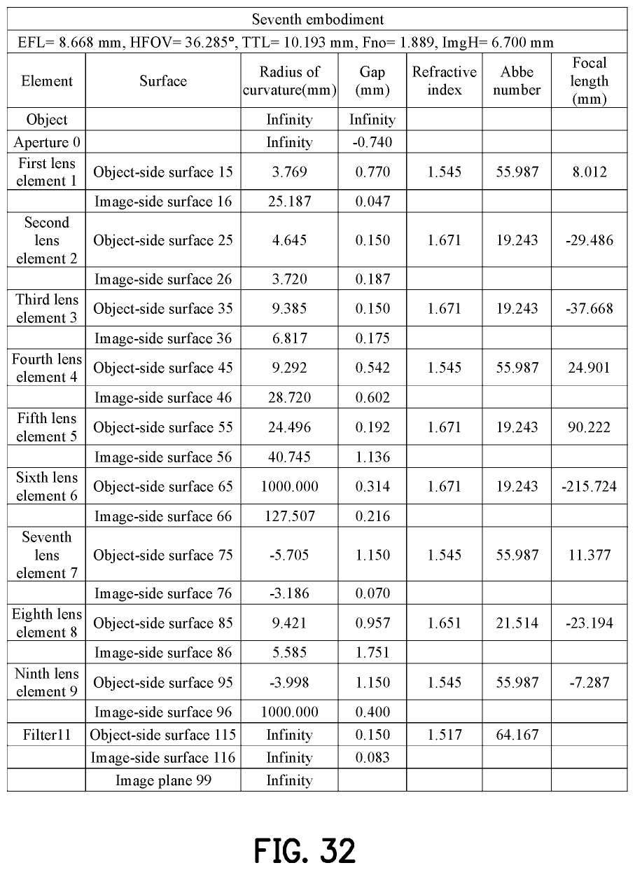

The detailed optical data of the optical imaging lens 10 of the seventh embodiment is shown in FIG. 32. In addition, the effective focal length (EFL) of the optical imaging lens 10 of the seventh embodiment is 8.668 mm, the half field of view (HFOV) is 36.285 degrees, the system length (TTL) is 10.193 mm, the F-number (Fno) is 1.889, and the image height (ImgH) is 6.700 mm.

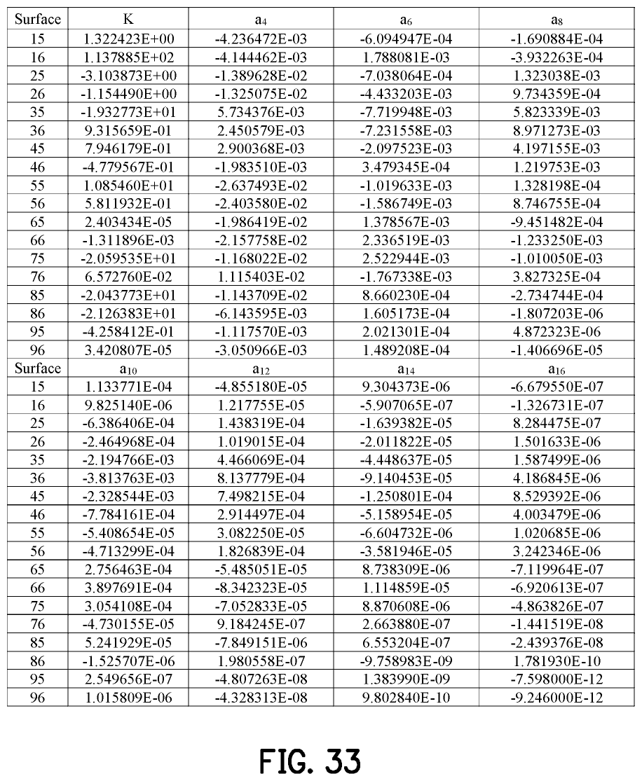

As shown in FIG. 33, the aspheric coefficients of the object-side surface 15 of the first lens element 1 to the image-side surface 96 of the ninth lens element 9 of the seventh embodiment in the formula (1) are illustrated.

In addition, the relationship among the important parameters in the optical imaging lens 10 of the seventh embodiment is shown in FIG. 39.

In FIG. 31A illustrating the longitudinal spherical aberration of the seventh embodiment, the deviation of the imaging point of off-axis rays of different heights is controlled within a range of ±0.015 mm. In the two field curvature aberration diagrams of FIG. 31B and FIG. 31C, the field curvature aberrations of the three representative wavelengths within the entire field of view fall within ±30 μm. The distortion aberration diagram of FIG. 31D illustrates that the distortion aberration of the seventh embodiment is maintained within the range of ±5.5%. Accordingly, compared with the existing optical imaging lens, under the condition that the system length is about 10.193 mm, the seventh embodiment may provide the F-number (Fno) of 1.889 and the image height of 6.700 mm and may provide good imaging quality and good chromatic aberration performance.

According to the foregoing description, compared with the first embodiment, the seventh embodiment has advantages as follows. The longitudinal aberration, the field curvature aberration, and the distortion aberration of the seventh embodiment outperform those of the first embodiment. The thickness difference between the optical axis region and the periphery region of the seventh embodiment is less than that of the first embodiment, which is easy to manufacture and thus has a higher yield.

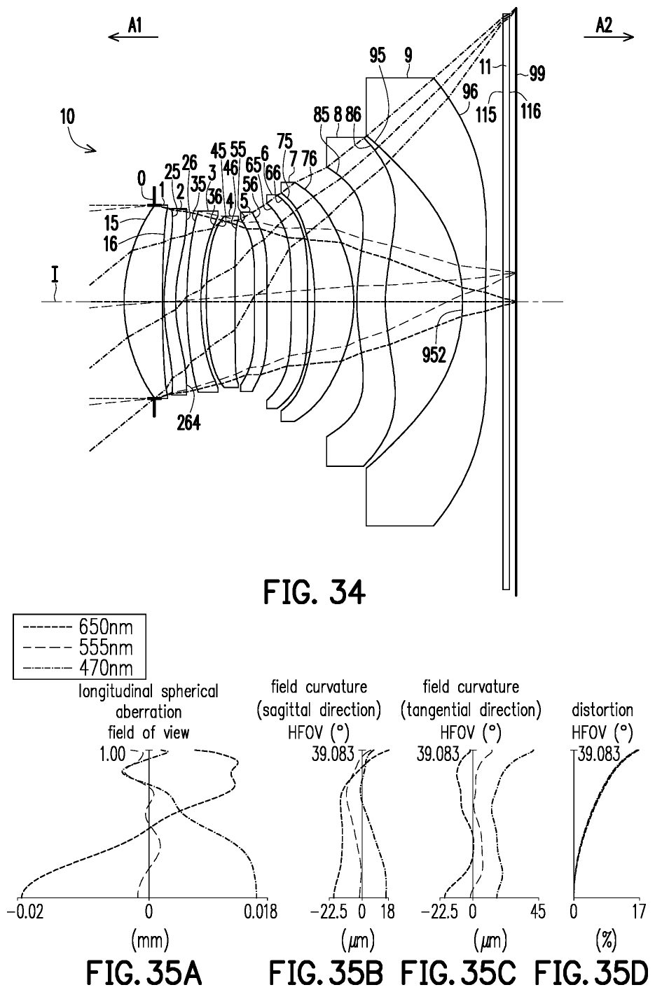

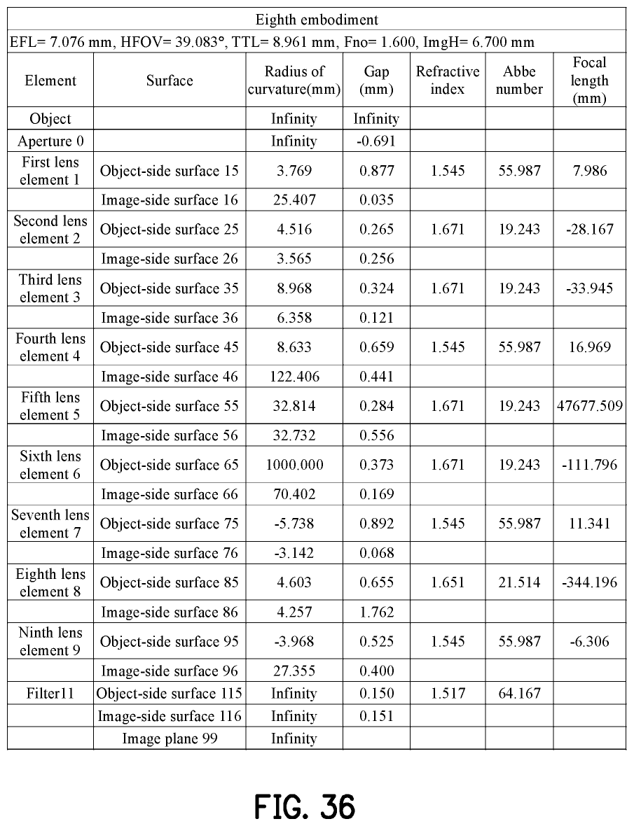

FIG. 34 is a schematic view of an optical imaging lens according to an eighth embodiment of the invention, and FIG. 35A to FIG. 35D are diagrams of longitudinal spherical aberration and various aberrations of the optical imaging lens of the eighth embodiment. Referring to FIG. 34 first, the optical imaging lens 10 of the eighth embodiment of the invention is substantially similar to that of the first embodiment, and what differs is illustrated as follows. Various optical data, aspheric coefficients, and the parameters of the lens elements 1, 2, 3, 4, 5, 6, 7, 8, and 9 are more or less different. In addition, in the embodiment, the sixth lens element 6 has negative refracting power, the eighth lens element 8 has negative refracting power, the ninth lens element 9 has negative refracting power, the periphery region 264 of the image-side surface 26 of the second lens element 2 is concave, and the optical axis region 952 of the object-side surface 95 of the ninth lens element 9 is concave. Meanwhile, note that for the clarity of the drawing, the reference numerals of the optical axis region and the periphery region similar to those in the first embodiment are omitted in FIG. 34.

The detailed optical data of the optical imaging lens 10 of the eighth embodiment is shown in FIG. 32. In addition, the effective focal length (EFL) of the optical imaging lens 10 of the eighth embodiment is 7.076 mm, the half field of view (HFOV) is 39.083 degrees, the system length (TTL) is 8.961 mm, the F-number (Fno) is 1.600, and the image height (ImgH) is 6.700 mm.

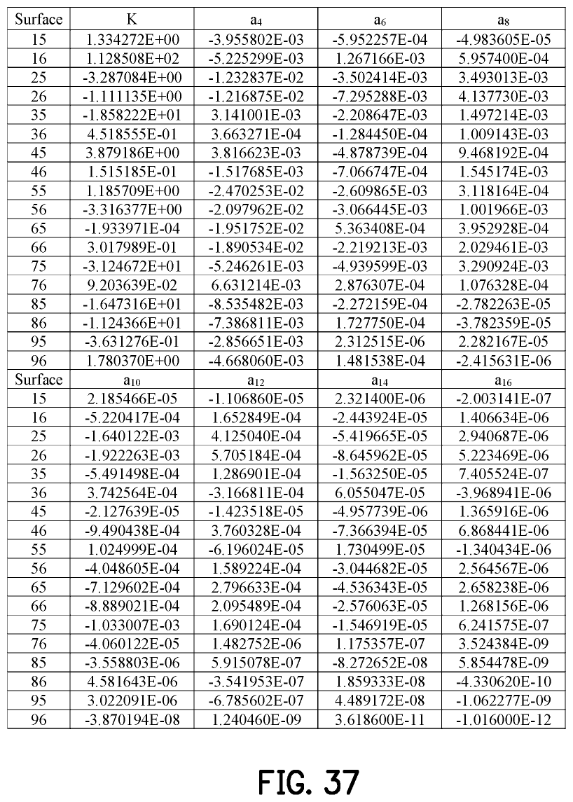

As shown in FIG. 37, the aspheric coefficients of the object-side surface 15 of the first lens element 1 to the image-side surface 96 of the ninth lens element 9 of the eighth embodiment in the formula (1) are illustrated.

In addition, the relationship among the important parameters in the optical imaging lens 10 of the eighth embodiment is shown in FIG. 39.

In FIG. 35A illustrating the longitudinal spherical aberration of the eighth embodiment, the deviation of the imaging point of off-axis rays of different heights is controlled within a range of ±0.02 mm. In the two field curvature aberration diagrams of FIG. 35B and FIG. 35C, the field curvature aberrations of the three representative wavelengths within the entire field of view fall within ±45 μm. The distortion aberration diagram of FIG. 35D illustrates that the distortion aberration of the eighth embodiment is maintained within the range of ±17%. Accordingly, compared with the existing optical imaging lens, under the condition that the system length is about 8.961 mm, the eighth embodiment may provide the F-number (Fno) of 1.600 and the image height of 6.700 mm and may provide good imaging quality and good chromatic aberration performance.

According to the foregoing description, compared with the first embodiment, the eighth embodiment has advantages as follows. The half field of view (HFOV) of the eighth embodiment is greater than that of the first embodiment, and the longitudinal aberration, the field curvature aberration, and the distortion aberration of the eighth embodiment outperform those of the first embodiment.

With the aid of the following numerical control of the optical properties and parameters of the lenses, designers may design a technically feasible optical imaging lens with a larger aperture, a larger image height, and higher resolution.

In the embodiment of the invention, the optical imaging lens satisfies that the optical axis region of the object-side surface of the second lens element is convex, the fourth lens element has positive refracting power, the periphery region of the image-side surface of the fourth lens element is concave, the periphery region of the object-side surface of the fifth lens element is concave, and the seventh lens element has positive refracting power, which contributes to the design of a lens with a large aperture and a large image height.

In the embodiment of the invention, the optical imaging lens satisfies that the periphery region of the image-side surface of the fourth lens element is concave, the periphery region of the object-side surface of the fifth lens element is concave, the optical axis region of the image-side surface of the sixth lens element is concave, and the optical axis region of the image-side surface of the seventh lens element is convex, which contributes to the design of a lens with a large aperture and a large image height.

In the embodiment of the invention, the optical imaging lens satisfies that the periphery region of the image-side surface of the third lens element is concave, the periphery region of the object-side surface of the fourth lens element is convex, the periphery region of the image-side surface of the fourth lens element is concave, the periphery region of the object-side surface of the fifth lens element is concave, the periphery region of the image-side surface of the fifth lens element is convex, and the optical axis region of the object-side surface of the sixth lens element is convex, which contributes to the design of a lens with a large aperture and a large image height.

Furthermore, in some embodiments of the invention, the optical imaging lens meets (V3+V4+V5+V6)/V2≤6.900, V1+V3≤100.000, or V3+V7≤100.000, which contributes to improving the modulation transfer function (MTF) of the optical imaging lens to increase the resolution. A preferred range is 1.350 (V3+V4+V5+V6)/V2≤6.900, 38.000≤V1+V3≤100.000, or 38.000≤V3+V7≤100.000.

The optical imaging lens of the invention can further meet the conditions as follows to help maintain a proper value of the thickness and interval of each lens under the premise of providing a lens with a large aperture and a large image height, any too large parameter that does not contribute to the overall thinning of the optical imaging lens is prevented, or any too small parameter that affects assembly or increases the difficulty in manufacturing is prevented.

(TTL+EPD)/D21t52≥5.200, preferably 5.200≤(TTL+EPD)/D21t52≤8.200;

(ALT16+BFL)/D71t82≤3.600, preferably 0.700≤(ALT16+BFL)/D71t82≤3.600;

Fno*(AA14+T6+G78)/T1≤3.500, preferably 1.700≤Fno*(AA14+T6+G78)/T1≤3.500;

ALT/(T7+T8)≤4.200, preferably 1.700≤ALT/(T7+T8)≤4.200;

(EPD+D42t92)/D11t42≥3.100, preferably 3.100≤(EPD+D42t92)/D11t42≥6.600;

(TL+EPD)/D11t42≥4.100, preferably 4.100≤(TL+EPD)/D11t42≤7.700;

D21t42/G45≤4.100, preferably 1.500≤D21t42/G45≤4.100;

Fno*ALT16/ALT79≤3.800, preferably 1.100≤Fno*ALT16/ALT79≤3.800;

(D21t52+BFL)/(G56+G67≤4.300, preferably 1.400≤(D21t52+BFL)/(G56+G67≤4.300;

(ImgH+D71t92)/D21t52≥3.300, preferably 3.300≤(ImgH+D71t92)/D21t52≤7.200;

(EFL+EPD)/(G12+D21t52)≥3.200, preferably 3.200≤(EFL+EPD)/(G12+D21t52)≤7.200;

D11t42/(G56+G67)≤3.500, preferably 1.300≤D11t42/(G56+G67)≤3.500;

Fno*D11t52/(G89+T9)≤3.800, preferably 1.700≤Fno*D11t52/(G89+T9)≤3.800;

D11t71/D71t82≤2.500, preferably 0.900≤D11t71/D71t82≤2.500.

In addition, any combination of the parameters of the embodiment can be selected to increase the lens limit, so as to facilitate the lens design of the same structure of the invention.

In view of the unpredictability of the optical system design, under the framework of the invention, when the conditions are met, the system length of the invention can be preferably shortened, and the previous technological defects may be improved by increasing the available aperture, improving the imaging quality, or improving the assembly yield.

The foregoing exemplary limiting relational conditions can also be optionally combined with unequal quantities and applied to the embodiments of the invention, but are not limited thereto. In the implementation of the invention, in addition to the relational conditions, detailed structures such as the arrangement of concave-convex curved surfaces of other lenses can be additionally designed for a single lens element or for multiple lens elements in a widespread manner, so as to enhance the system performance and/or resolution control. Note that these details may be optionally incorporated into other embodiments of the invention without conflicts.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

(1) The ranges of the optical parameters are, for example, a₂≤A≤α₁ or β₂≤B≤β₁, where a₁ is a maximum value of the optical parameter A among the plurality of embodiments, a₂ is a minimum value of the optical parameter A among the plurality of embodiments, β₁ is a maximum value of the optical parameter B among the plurality of embodiments, and β₂ is a minimum value of the optical parameter B among the plurality of embodiments.

(2) The comparative relation between the optical parameters is that A is greater than B or A is less than B, for example.

(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

What is claimed is:

1. An optical imaging lens, comprising a first lens element, a second lens element, a third lens element, a fourth lens element, a fifth lens element, a sixth lens element, a seventh lens element, an eighth lens element, and a ninth lens element disposed in sequence from an object side to an image side along an optical axis, wherein each of the first lens element to the ninth lens element comprises an object-side surface facing the object side and allowing imaging rays to pass through and an image-side surface facing the image side and allowing the imaging rays to pass through;
an optical axis region of the object-side surface of the second lens element is convex;
the fourth lens element has positive refracting power and a periphery region of the image-side surface of the fourth lens element is concave;
a periphery region of the object-side surface of the fifth lens element is concave;
the seventh lens element has positive refracting power;
wherein lens elements of the optical imaging lens are only the nine lens elements described above.

2. The optical imaging lens according to claim 1, wherein the optical imaging lens further meets (V3+V4+V5+V6)/V2≤6.900, where V2 is an Abbe number of the second lens element, V3 is an Abbe number of the third lens element, V4 is an Abbe number of the fourth lens element, V5 is an Abbe number of the fifth lens element, and V6 is an Abbe number of the sixth lens element.

3. The optical imaging lens according to claim 1, wherein the optical imaging lens meets (TTL+EPD)/D21t52≥5.200, where TTL is a distance from the object-side surface of the first lens element to an image plane on the optical axis, EPD is an entrance pupil diameter of the optical imaging lens, D21t52 is a distance from the object-side surface of the second lens element to the image-side surface of the fifth lens element on the optical axis.

4. The optical imaging lens according to claim 1, wherein the optical imaging lens further meets (ALT16+BFL)/D71t82≤3.600, where ALT16 is a sum of six thicknesses of the first lens element to the sixth lens element on the optical axis, BFL is a distance from the image-side surface of the ninth lens element to an image plane on the optical axis, and D11t82 is a distance from the object-side surface of the seventh lens element to the image-side surface of the eighth lens element on the optical axis.

5. The optical imaging lens according to claim 1, wherein the optical imaging lens further meets Fno*(AA14+T6+G78)/T1≤3.500, where Fno is an F-number of the optical imaging lens, AA14 is a sum of four air gaps from the first lens element to the fifth lens element on the optical axis, T1 is a thickness of the first lens element on the optical axis, T6 is a thickness of the sixth lens element on the optical axis, and G78 is an air gap between the seventh lens element and the eighth lens element on the optical axis.

6. The optical imaging lens according to claim 1, wherein the optical imaging lens further meets ALT/(T7+T8)≤4.200, where ALT is a sum of nine thicknesses of the first lens element to the ninth lens element on the optical axis, T7 is a thickness of the seventh lens element on the optical axis, and T8 is a thickness of the eighth lens element on the optical axis.

7. The optical imaging lens according to claim 1, wherein the optical imaging lens further meets (EPD+D42t92)/D11t42≥3.100, where EPD is an entrance pupil diameter of the optical imaging lens, D42t92 is a distance from the image-side surface of the fourth lens element to the image-side surface of the ninth lens element on the optical axis, and D11t42 is a distance from the object-side surface of the first lens element to the image-side surface of the fourth lens element on the optical axis.

8. An optical imaging lens, comprising a first lens element, a second lens element, a third lens element, a fourth lens element, a fifth lens element, a sixth lens element, a seventh lens element, an eighth lens element, and a ninth lens element disposed in sequence from an object side to an image side along an optical axis, wherein each of the first lens element to the ninth lens element comprises an object-side surface facing the object side and allowing imaging rays to pass through and an image-side surface facing the image side and allowing the imaging rays to pass through;
a periphery region of the image-side surface of the fourth lens element is concave;
a periphery region of the object-side surface of the fifth lens element is concave;
an optical axis region of the image-side surface of the sixth lens element is concave;
an optical axis region of the image-side surface of the seventh lens element is convex;
wherein lens elements of the optical imaging lens are only the nine lens elements described above.

9. The optical imaging lens according to claim 8, wherein the optical imaging lens further meets V1+V3≤100.000, where V1 is an Abbe number of the first lens element, and V3 is an Abbe number of the third lens element.

10. The optical imaging lens according to claim 8, wherein the optical imaging lens further meets (TL+EPD)/D11t42≥4.100, where TL is a distance from the object-side surface of the first lens element to the image-side surface of the ninth lens element on the optical axis, EPD is an entrance pupil diameter of the optical imaging lens, and D11t42 is a distance from the object-side surface of the first lens element to the image-side surface of the fourth lens element on the optical axis.

11. The optical imaging lens according to claim 8, wherein the optical imaging lens further meets D21t42/G45≤4.100, where D21t42 is a distance from the object-side surface of the second lens element to the image-side surface of the fourth lens element on the optical axis, and G45 is an air gap between the fourth lens element and the fifth lens element on the optical axis.

12. The optical imaging lens according to claim 8, wherein the optical imaging lens further meets Fno*ALT16/ALT79≤3.800, where Fno is an F-number of the optical imaging lens, ALT16 is a sum of six thicknesses of the first lens element to the sixth lens element on the optical axis, and ALT79 is a sum of three thicknesses of the seventh lens element to the ninth lens element on the optical axis.

13. The optical imaging lens according to claim 8, wherein the optical imaging lens further meets (D21t52+BFL)/(G56+G67)≤4.300, where D21t52 is a distance from the object-side surface of the second lens element to the image-side surface of the fifth lens element on the optical axis, BFL is a distance from the image-side surface of the ninth lens element to an image plane on the optical axis, G56 is an air gap between the fifth lens element and the sixth lens element on the optical axis, and G67 is an air gap between the sixth lens element and the seventh lens element on the optical axis.

14. The optical imaging lens according to claim 8, wherein the optical imaging lens further meets (ImgH+D71t92)/D21t52≥3.300, where ImgH is an image height of the optical imaging lens, D71t92 is a distance from the object-side surface of the seventh lens element to the image-side surface of the ninth lens element on the optical axis, and D21t52 is a distance from the object-side surface of the second lens element to the image-side surface of the fifth lens element on the optical axis.

15. An optical imaging lens, comprising a first lens element, a second lens element, a third lens element, a fourth lens element, a fifth lens element, a sixth lens element, a seventh lens element, an eighth lens element, and a ninth lens element disposed in sequence from an object side to an image side along an optical axis, wherein each of the first lens element to the ninth lens element comprises an object-side surface facing the object side and allowing imaging rays to pass through and an image-side surface facing the image side and allowing the imaging rays to pass through;
a periphery region of the image-side surface of the third lens element is concave;
a periphery region of the object-side surface of the fourth lens element is convex, and a periphery region of the image-side surface of the fourth lens element is concave;
a periphery region of the object-side surface of the fifth lens element is concave, and a periphery region of the image-side surface of the fifth lens element is convex;
an optical axis region of the object-side surface of the sixth lens element is convex;
wherein lens elements of the optical imaging lens are only the nine lens elements described above.

16. The optical imaging lens according to claim 15, wherein the optical imaging lens further meets V3+V7≤100.000, where V3 is an Abbe number of the third lens element, and V7 is an Abbe number of the seventh lens element.

17. The optical imaging lens according to claim 15, wherein the optical imaging lens further meets (EFL+EPD)/(G12+D21t52)≥3.200, where EFL is an effective focal length of the optical imaging lens, EPD is an entrance pupil diameter of the optical imaging lens, G12 is an air gap between the first lens element and the second lens element on the optical axis, and D21t52 is a distance from the object-side surface of the second lens element to the image-side surface of the fifth lens element on the optical axis.

18. The optical imaging lens according to claim 15, wherein the optical imaging lens further meets D11t42/(G56+G67)≤3.500, where D11t42 is a distance from the object-side surface of the first lens element to the image-side surface of the fourth lens element on the optical axis, G56 is an air gap between the fifth lens element and the sixth lens element on the optical axis, and G67 is an air gap between the sixth lens element and the seventh lens element on the optical axis.

19. The optical imaging lens according to claim 15, wherein the optical imaging lens further meets Fno*D11t52/(G89+T9)≤3.800, where Fno is an F-number of the optical imaging lens, D11t52 is a distance from the object-side surface of the first lens element to the image-side surface of the fifth lens element on the optical axis, G89 is an air gap between the eighth lens element and the ninth lens element on the optical axis, and T9 is a thickness of the ninth lens element on the optical axis.

20. The optical imaging lens according to claim 15, wherein the optical imaging lens further meets D11t71/D71t82≤2.500, where D11t71 is a distance from the object-side surface of the first lens element to the object-side surface of the seventh lens element on the optical axis, and D71t82 is a distance from the object-side surface of the seventh lens element to the image-side surface of the eighth lens element on the optical axis.
